(19) United States
(12) Patent Application Publication
(10) Pub. No.: US 2024/0179665 A1
(43) Pub. Date: May 30, 2024

(54) MOVING ANCHOR NODES FOR POSITIONING OPERATIONS

(71) Applicant: QUALCOMM Incorporated, San Diego, CA (US)

(72) Inventors: Sony AKKARAKARAN, Poway, CA (US); Tao LUO, San Diego, CA (US); Junyi LI, Fairless Hills, PA (US); Jingchao BAO, San Diego, CA (US); Thomas Joseph RICHARDSON, South Orange, NJ (US); Juan MONTOJO, San Diego, CA (US); Wanshi CHEN, San Diego, CA (US)

(21) Appl. No.: 18/059,913

(22) Filed: Nov. 29, 2022

(51) Int. Cl. H04W 64/00; G01S 5/02

(52) U.S. Cl. CPC H04W 64/00; G01S 5/0284

(57) ABSTRACT

Disclosed are techniques for wireless communication. In an aspect, one or more processing devices may identify a set of candidate anchor nodes based on a target node. The one or more processing devices may identify a set of candidate anchor locations based on location information of the target node, location information of the set of candidate anchor nodes, mobility capabilities of the set of candidate anchor nodes, or a combination thereof. The one or more processing devices may instruct at least a subset of the set of candidate anchor nodes to move based on the set of candidate anchor locations. The one or more processing devices may configure the set of candidate anchor nodes and the target node to engage in positioning operations at a positioning time to determine a position estimation of the target node.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of positioning a target node includes identifying a set of candidate anchor nodes based on the target node: identifying a set of candidate anchor locations based on location information of the target node, location information of the set of candidate anchor nodes, mobility capabilities of the set of candidate anchor nodes, or a combination thereof: instructing at least a subset of the set of candidate anchor nodes to move based on the set of candidate anchor locations: and configuring the set of candidate anchor nodes and the target node to engage in positioning operations at a positioning time to determine a position estimation of the target node.

In an aspect, a method of positioning a target node includes identifying multiple anchor locations for an anchor node, the anchor node being placed at the multiple anchor locations at different time points: configuring the anchor node and the target node to engage in positioning operations based on the anchor node at the multiple anchor locations: and determining a position estimation of the target node based on results of the positioning operations.

In an aspect, a method of positioning a target node includes obtaining two or more relative positions of the target node, wherein each position of the two or more relative positions is relative to a previous position of the two or more relative positions: obtaining, for each position of the target node at the two or more relative positions, ranging measurements, angle measurements, timing measurements, or a combination thereof, between the target node and one or more anchor nodes: and determining an absolute position of the target node based on the two or more relative positions of the target node, the ranging measurements, and known locations of the one or more anchor nodes.

In an aspect, an apparatus for positioning a target node includes a memory: at least one transceiver: and at least one processor communicatively coupled to the memory and the at least one transceiver, the at least one processor configured to: identify a set of candidate anchor nodes based on the target node: identify a set of candidate anchor locations based on location information of the target node, location information of the set of candidate anchor nodes, mobility capabilities of the set of candidate anchor nodes, or a combination thereof: instruct at least a subset of the set of candidate anchor nodes to move based on the set of candidate anchor locations: and configure the set of candidate anchor nodes and the target node to engage in positioning operations at a positioning time to determine a position estimation of the target node.

In an aspect, an apparatus for positioning a target node includes a memory: at least one transceiver: and at least one processor communicatively coupled to the memory and the at least one transceiver, the at least one processor configured to: identify multiple anchor locations for an anchor node, the anchor node being placed at the multiple anchor locations at different time points: configure the anchor node and the target node to engage in positioning operations based on the anchor node at the multiple anchor locations: and determine a position estimation of the target node based on results of the positioning operations.

In an aspect, an apparatus for positioning a target node includes a memory: at least one transceiver: and at least one processor communicatively coupled to the memory and the at least one transceiver, the at least one processor configured to: obtain two or more relative positions of the target node, wherein each position of the two or more relative positions is relative to a previous position of the two or more relative positions: obtain, for each position of the target node at the two or more relative positions, ranging measurements, angle measurements, timing measurements, or a combination thereof, between the target node and one or more anchor nodes: and determine an absolute position of the target node based on the two or more relative positions of the target node, the ranging measurements, and known locations of the one or more anchor nodes.

In an aspect, an apparatus for positioning a target node includes means for identifying a set of candidate anchor nodes based on the target node: means for identifying a set of candidate anchor locations based on location information of the target node, location information of the set of candidate anchor nodes, mobility capabilities of the set of candidate anchor nodes, or a combination thereof: means for instructing at least a subset of the set of candidate anchor nodes to move based on the set of candidate anchor locations: and means for configuring the set of candidate anchor nodes and the target node to engage in positioning operations at a positioning time to determine a position estimation of the target node.

In an aspect, an apparatus for positioning a target node includes means for identifying multiple anchor locations for an anchor node, the anchor node being placed at the multiple anchor locations at different time points: means for configuring the anchor node and the target node to engage in positioning operations based on the anchor node at the multiple anchor locations: and means for determining a position estimation of the target node based on results of the positioning operations.

In an aspect, an apparatus for positioning a target node includes means for obtaining two or more relative positions of the target node, wherein each position of the two or more relative positions is relative to a previous position of the two or more relative positions; means for obtaining, for each position of the target node at the two or more relative positions, ranging measurements, angle measurements, timing measurements, or a combination thereof, between the target node and one or more anchor nodes: and means for determining an absolute position of the target node based on the two or more relative positions of the target node, the ranging measurements, and known locations of the one or more anchor nodes.

In an aspect, a non-transitory computer-readable medium stores computer-executable instructions that, when executed by an apparatus for positioning a target node, cause the apparatus to: identify a set of candidate anchor nodes based on the target node: identify a set of candidate anchor locations based on location information of the target node, location information of the set of candidate anchor nodes, mobility capabilities of the set of candidate anchor nodes, or a combination thereof: instruct at least a subset of the set of candidate anchor nodes to move based on the set of candidate anchor locations: and configure the set of candidate anchor nodes and the target node to engage in positioning operations at a positioning time to determine a position estimation of the target node.

In an aspect, a non-transitory computer-readable medium stores computer-executable instructions that, when executed by an apparatus for positioning a target node, cause the apparatus to: identify multiple anchor locations for an anchor node, the anchor node being placed at the multiple anchor locations at different time points: configure the anchor node and the target node to engage in positioning operations based on the anchor node at the multiple anchor locations: and determine a position estimation of the target node based on results of the positioning operations.

In an aspect, a non-transitory computer-readable medium stores computer-executable instructions that, when executed by an apparatus for positioning a target node, cause the apparatus to: obtain two or more relative positions of the target node, wherein each position of the two or more relative positions is relative to a previous position of the two or more relative positions: obtain, for each position of the target node at the two or more relative positions, ranging measurements, angle measurements, timing measurements, or a combination thereof, between the target node and one or more anchor nodes; and determine an absolute position of the target node based on the two or more relative positions of the target node, the ranging measurements, and known locations of the one or more anchor nodes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIGS. 5A and 5B illustrate various scenarios of interest for sidelink-only or joint Uu and sidelink positioning, according to aspects of the disclosure.

FIG. 6 illustrates an example method of positioning one or more target nodes, according to aspects of the disclosure.

FIGS. 7A-7D show various examples of candidate anchor locations with respect to a target node, according to aspects of the disclosure

FIG. 8 shows an example of moving a physical anchor node to create multiple virtual anchor nodes, according to aspects of the disclosure.

FIGS. 9A and 9B show an example of moving a target node to work with only a limited amount of anchor nodes, according to aspects of the disclosure.

FIG. 10 illustrates an example method of positioning a target node, according to aspects of the disclosure.

FIG. 11 illustrates another example method of positioning a target node, according to aspects of the disclosure.

FIG. 12 illustrates yet another example method of positioning a target node, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

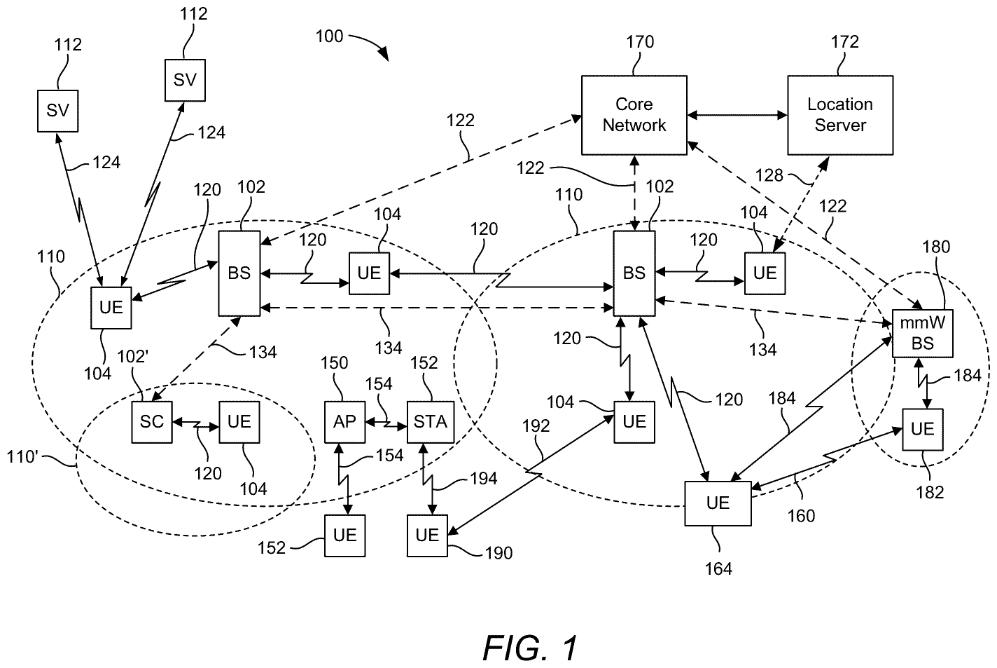

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHZ unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHZ, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30) GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHz-300 GHz). Each of these higher frequency bands falls within the EHF band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHZ aggregated carriers in a multi-carrier system would theoretically lead to a two-fold increase in data rate (i.e., 40 MHZ), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102″, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

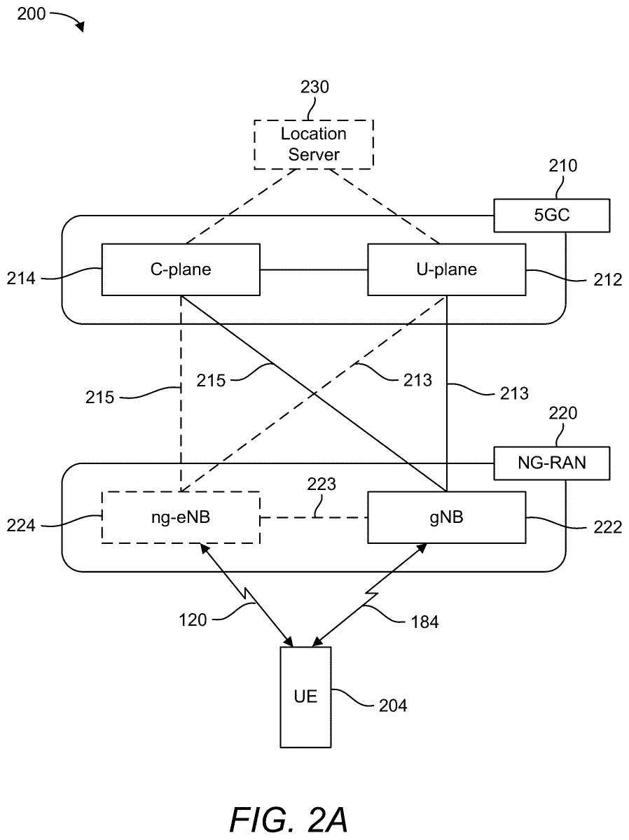

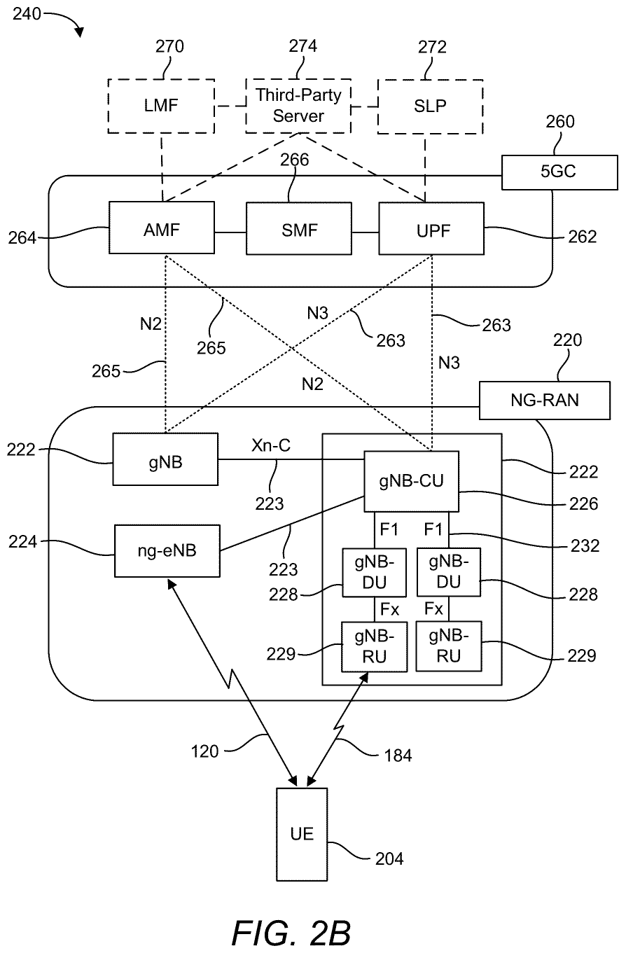

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270) can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

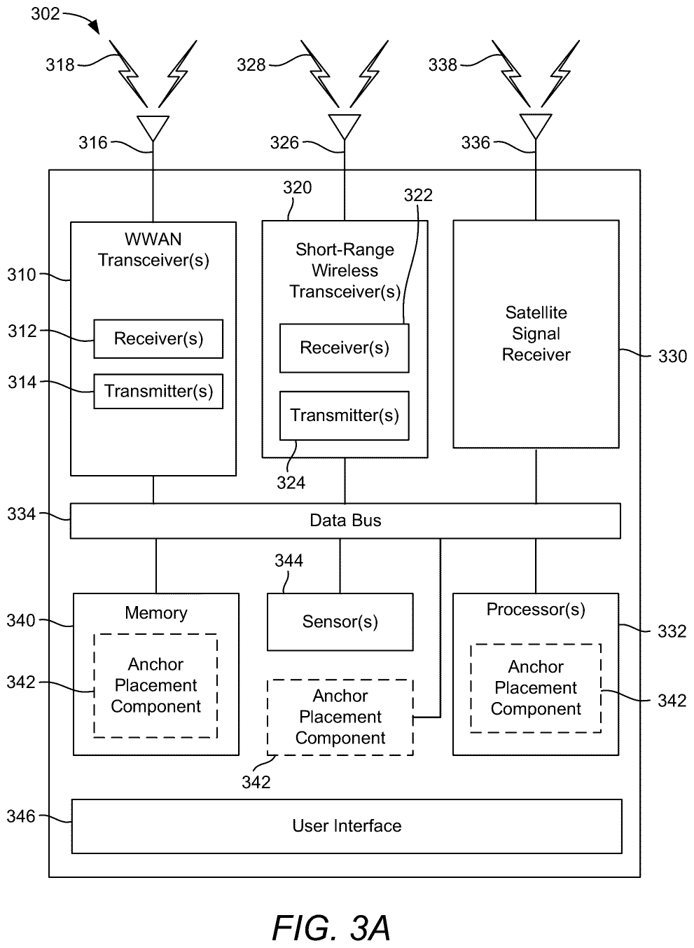

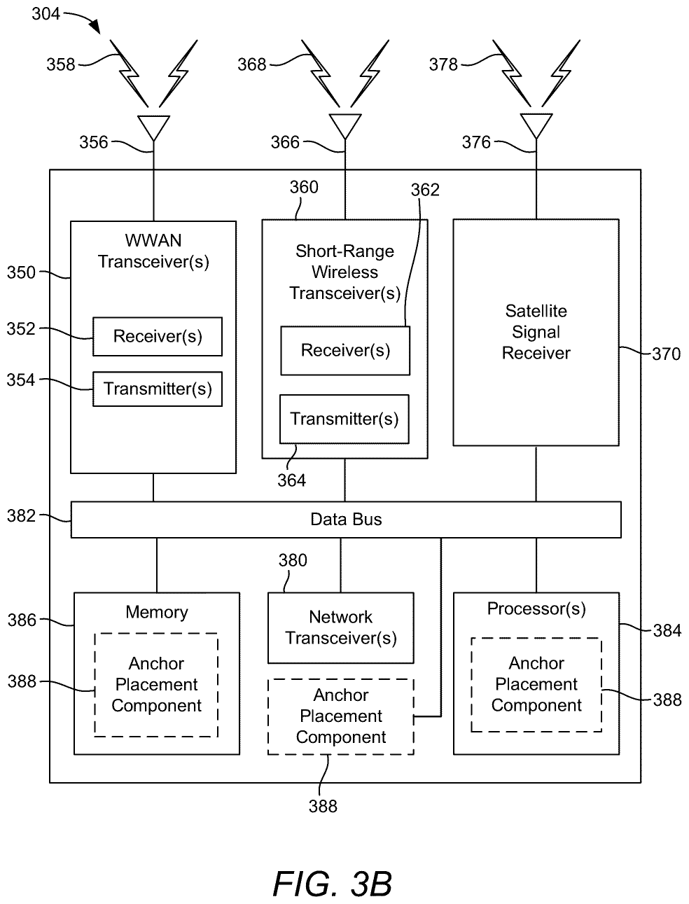

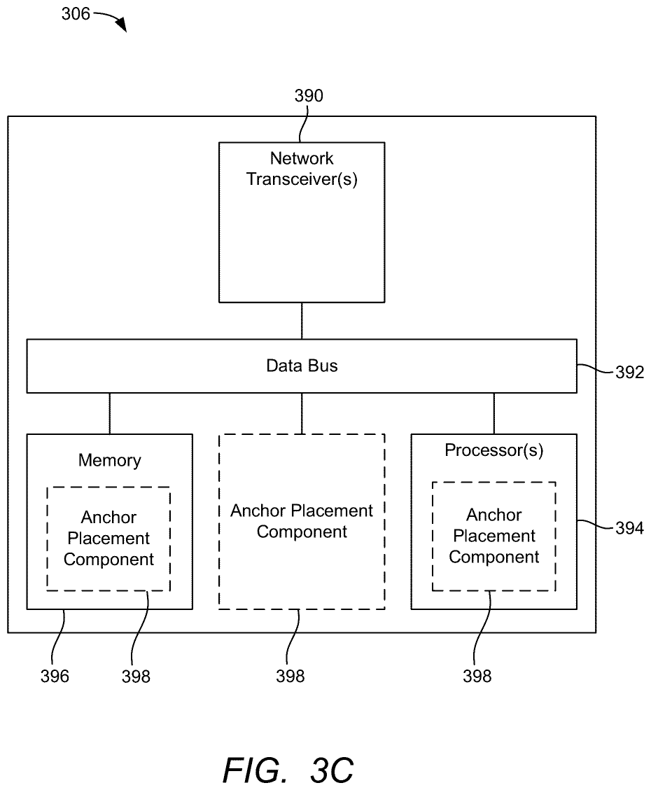

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth®; transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include anchor placement component 342, 388, and 398, respectively. The anchor placement component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the anchor placement component 342, 388, and 398 may be external to the processors 332, 384, and 394 (e.g., part of a modem processing system, integrated with another processing system, etc.). Alternatively, the anchor placement component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the anchor placement component 342, which may be, for example, part of the memory 340), the one or more processors 332, or any combination thereof, or may be a standalone component. FIG. 3B illustrates possible locations of the anchor placement component 388, which may be, for example, part of the memory 386, the one or more processors 384, or any combination thereof, or may be a standalone component. FIG. 3C illustrates possible locations of the anchor placement component 398, which may be, for example, part of the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs: and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320) (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the anchor placement component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

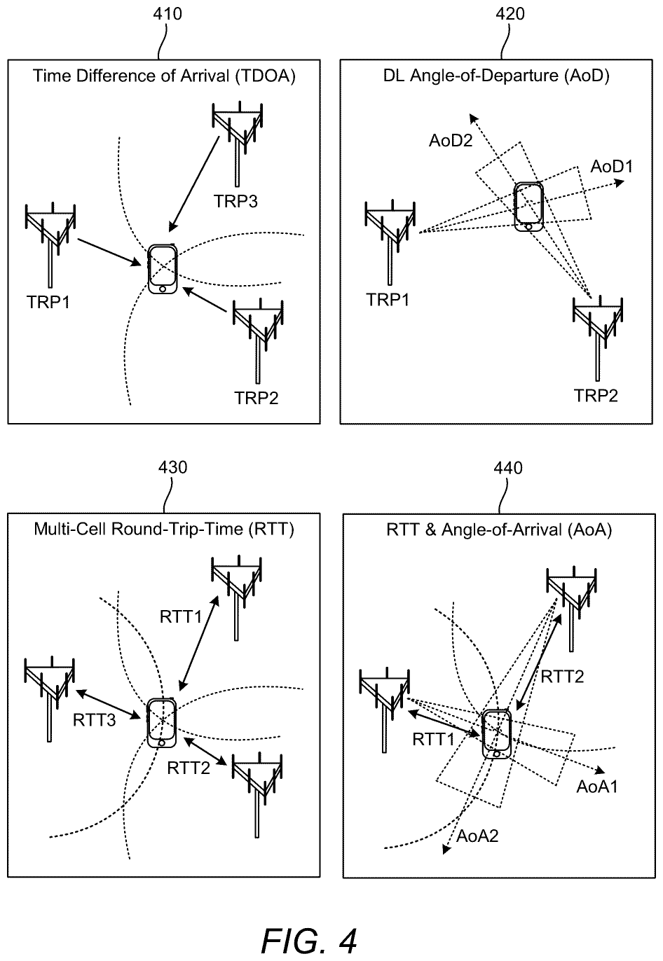

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420), the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

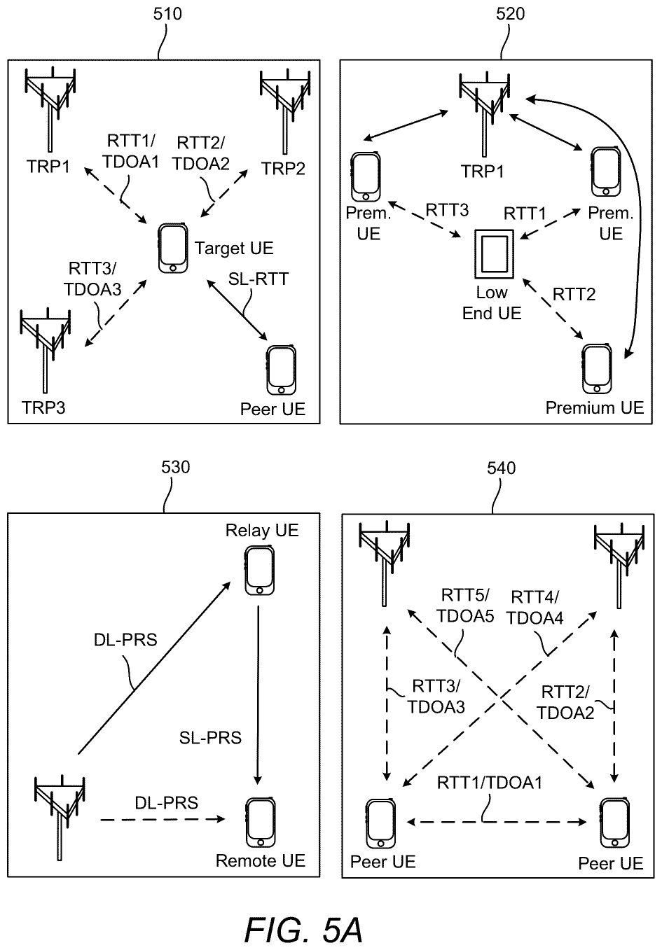

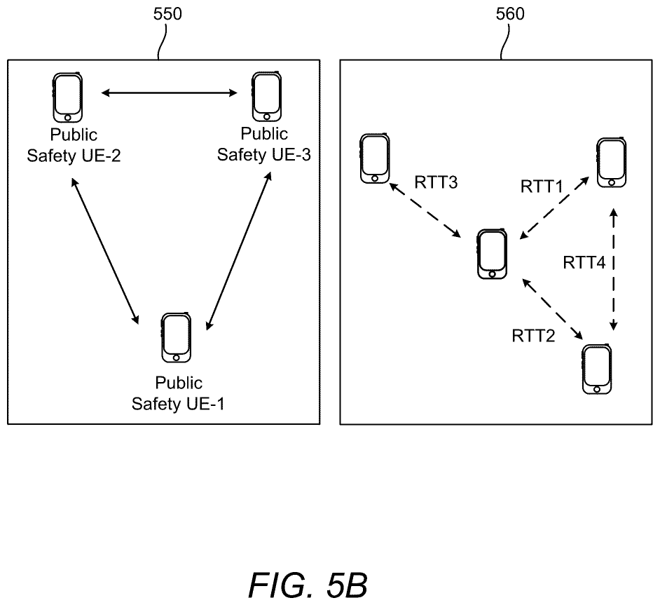

NR supports, or enables, various sidelink positioning techniques. FIG. 5A illustrates various scenarios of interest for sidelink-only or joint Uu and sidelink positioning, according to aspects of the disclosure. In scenario 510, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 520, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 530, a relay UE (e.g., with a known location) participates in the positioning estimation of a remote UE without performing uplink positioning reference signal (PRS) transmission over the Uu interface. Scenario 540 illustrates the joint positioning of multiple UEs. Specifically, in scenario 540, two UEs with unknown positions can be jointly located in non-line-of-sight (NLOS) conditions by utilizing constraints from nearby UEs.

FIG. 5B illustrates additional scenarios of interest for sidelink-only or joint Uu and sidelink positioning, according to aspects of the disclosure. In scenario 550, UEs used for public safety (e.g., by police, firefighters, and/or the like) may perform peer-to-peer (P2P) positioning and ranging for public safety and other uses. For example, in scenario 550, the public safety UEs may be out of coverage of a network and determine a location or a relative distance and a relative position among the public safety UEs using sidelink positioning techniques. Similarly, scenario 560 shows multiple UEs that are out of coverage and determine a location or a relative distance and a relative position using sidelink positioning techniques, such as SL-RTT.

In some aspects, a UE or other wireless device may be configured as a target node that a position thereof is to be determined by performing a positioning estimation procedure. In some aspects, a target node may be referred to in this disclosure as a target UE, a target wireless device, a target wireless node, or simply a target. In some aspects, a base station, a UE, an SL-UE, a roadside unit (RSU), or other wireless device may be configured as an anchor node that has a known location and can perform positioning operations with the target, such as transmission and/or reception of reference signals between the target and the anchor. In some aspects, the anchor node may be referred to in this disclosure as an anchor device or simply an anchor, and a location of an anchor node is referred to in this disclosure as an anchor location.

The quality of an estimated position may be quantified using a metric referred to as geometric dilution of precision (GDOP), which may correspond to the effect on the precision of a positioning estimation procedure due to the geometric distribution of the anchor nodes with respect to the target node. In some aspects, the computation of a GDOP metric may use the locations of the anchor nodes and a coarse location of the target node.

For example, the positioning operations with various anchor nodes may have respective precisions based on the capabilities of the anchor nodes, the channel conditions, and/or the surrounding environments where the anchor nodes are located. When performing a positioning estimation procedure of a target node based on a combination of the positioning operations with the anchor nodes, a combined positioning precision may vary based on the relative geometric relationship between the anchor nodes and the target node. In some aspects, a low GDOP value represents better positioning estimation precision due to the wider angular separation between the anchor nodes used to calculate the target node's position. In some examples, when the anchor nodes are close together with respect to the target node, the geometric distribution of the anchor nodes is considered less preferable and may lead to a higher GDOP value. In some examples, when the anchor nodes are spread apart with respect to the target node, the geometric distribution of the anchor nodes is considered more preferable and may lead to a lower GDOP value.

In some aspects, placement or motion of the anchor nodes for positioning one or more target nodes may be controlled to improve the performance of the positioning estimation procedure, or to meet the requirements of various end use cases (e.g., an automated guided vehicle (AGV) in an industrial facility). Measurements for a positioning estimation procedure may be made during and/or after the motion of the anchor nodes. In some aspects, moving the anchor nodes to adjust the placement thereof may improve channel conditions, avoid blockage, or improve the GDOP of the position estimation of the target node. In some aspects, the motion of one anchor node may be used to create several virtual anchor nodes (i.e., the same anchor node performing measurements at different anchor locations at different time) in order to improve the GDOP (e.g., corresponding to a less GDOP value).

Therefore, according to various aspects of the present disclosure, the candidate anchor locations of the anchor nodes may be determined based on location information of a target node and location information of the anchor nodes, and the placement of the anchor nodes may be adjusted by instructing at least a subset of the anchor nodes to move based on the candidate anchor locations. Accordingly, the positioning estimation procedure of the target node may be performed with the anchor nodes at anchor locations that offer improved positioning performance and/or accuracy of the estimated position.

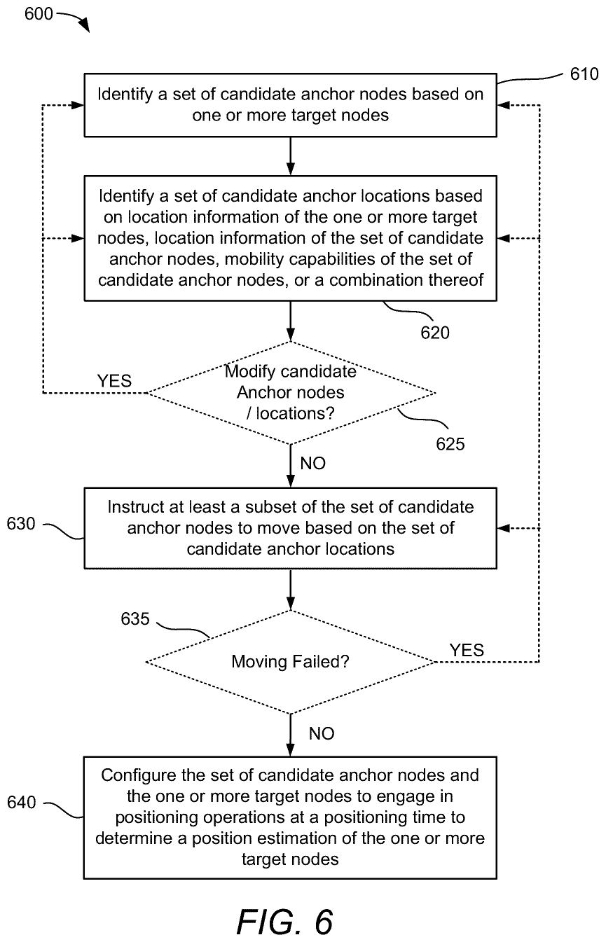

FIG. 6 illustrates an example method 600 of positioning one or more target nodes, according to aspects of the disclosure. In some aspects, method 600 may be performed by a network entity (e.g., any of the network entity, LMF, SLP, or server described herein), a UE (e.g., any of the UE described herein), or a TRP or base station (e.g., any of the TRP or base station described herein).

As a non-limiting example for illustration in this disclosure, method 600 may be performed in an environment that includes a mix of different types of nodes, including static or mobile nodes, positions of nodes being known or unknown, anchor or non-anchor nodes, and/or nodes that can or cannot be instructed to move for a positioning estimation procedure. In some aspects, accuracy of the known positions of nodes may vary for static and mobile nodes. In some aspects, an anchor node may be a UE, a gNB, or a SL-UE. The position of an anchor node may be known (e.g., when the anchor node is a positioning reference unit) or may be determined prior to, and/or as a part of, the positioning estimation procedure of the one or more target nodes.

At operation 610, the network entity, UE, or TRP or base station identifies a set of candidate anchor nodes based on the one or more target nodes, such as the identity, the general location, the last know location, proximity, and/or connectivity of the one or more target nodes, as further explained below. In some aspects, the processing device may first identify the one or more target nodes to be positioned. The processing device may further identify candidate anchor nodes to be used to position the one or more target nodes.

In some aspects, operation 610 may be performed by the one or more network transceivers 390, the one or more processors 394, memory 396, and/or anchor placement component 398, any or all of which may be considered means for performing operation 610. In some aspects, operation 610 may be performed by the one or more WWAN transceivers 310, the one or more processors 332, memory 340, and/or anchor placement component 342, any or all of which may be considered means for performing operation 610. In some aspects, operation 610 may be performed by the one or more WWAN transceivers 350, the one or more processors 384, memory 386, and/or anchor placement component 388, any or all of which may be considered means for performing operation 610.

In some aspects, the target nodes to be positioned may be referred to as primary targets and may be dictated by an end application (e.g., an application of V2X, industrial Internet of Things (IIoT), etc.).

In some aspects, the candidate anchor nodes may be referred to as secondary targets and may be determined by a positioning engine executed by the processing device to help with the positioning estimation procedure of the primary targets. In some aspects, the identifying the set of candidate anchor nodes may be performed based on one or more last recorded positions of the one or more target nodes, one or more established communication connections with the one or more target nodes, one or more signal strengths of signals measured by the target node, an estimated GDOP of the position estimation of the target node, node types (e.g., gNB, UE, SL-UE, RUS, etc.) of the set of candidate anchor nodes, node capabilities (e.g., capability to be moved or mobility capability) of the set of candidate anchor nodes, or a combination thereof.

For example, the candidate anchor nodes may be nodes near the prior known approximate location of the one or more target nodes. The nearness of the candidate anchor node to the one or more target nodes may be based on actual location information, RSRP measurements, or established connections with the one or more target nodes or with other nodes neighboring the one or more target nodes.

In some aspects, a server (e.g., the LMF) may act as a LCS-client for the candidate anchor nodes in order to initiate a positioning session for the candidate anchor nodes. In some aspects, when an anchor node is a positioning reference unit (PRU), the server may still initiate the positioning session for the PRU, even though the PRU's location may be known, in order to obtain measurements for various operations of the method 600.

In some aspects, the candidate anchor nodes may be based on suggested anchor nodes provided by the one or more target nodes or other nodes (e.g., by gNB, RSU, or a hub UE for signaling aggregation). Moreover, in some aspects, the candidate anchor nodes may further include any other nodes with positions already known, such as gNBs in NR Uu positioning.

At operation 620, the network entity, UE, or TRP or base station identifies a set of candidate anchor locations based on at least location information of the one or more target nodes, location information of the set of candidate anchor nodes, mobility capabilities of the set of candidate anchor nodes, or a combination thereof. In some aspects, the set of candidate anchor locations may be determined with or without assuming any or all of availability and current location information of the candidate anchor nodes. In some aspects, the set of candidate anchor locations may in particularly for placing anchor nodes where they are not currently present or for moving anchor nodes from their current locations.

In some aspects, operation 620 may be performed by the one or more network transceivers 390, the one or more processors 394, memory 396, and/or anchor placement component 398, any or all of which may be considered means for performing operation 620. In some aspects, operation 620 may be performed by the one or more WWAN transceivers 310, the one or more processors 332, memory 340, and/or anchor placement component 342, any or all of which may be considered means for performing operation 620. In some aspects, operation 620 may be performed by the one or more WWAN transceivers 350, the one or more processors 384, memory 386, and/or anchor placement component 388, any or all of which may be considered means for performing operation 620.

In some aspects, the set of candidate anchor locations may be identified based on an estimated GDOP of the position estimation of the one or more target nodes, node types of the set of candidate anchor nodes, a network topology of the set of candidate anchor nodes, a line-of-sight (LOS) condition, or a combination thereof. In some aspects, the location information of the one or more target nodes may indicate a coarse location (e.g., a general area based on established communication with a base station or based on a previously determined positioning estimation) of the one or more target nodes. In some aspects, the location information of the candidate anchor nodes may indicate coarse locations thereof based on UE reports indicating the presence and/or relative position estimations of the other UEs.

In some aspects, the knowledge of the parameters and information for identifying the set of candidate anchor locations may be extracted based on existing reporting procedures (by the UE and/or TRP or base station that performs operation 620 or by another device that reports to the network entity, UE, or TRP or base station that performs operation 620), or obtained in response to an explicit request (e.g., by the network entity, UE, or TRP or base station that performs operation 620).

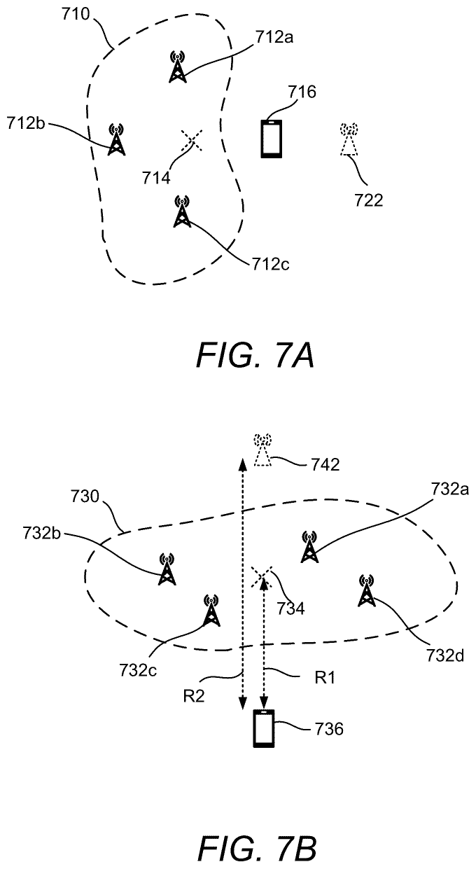

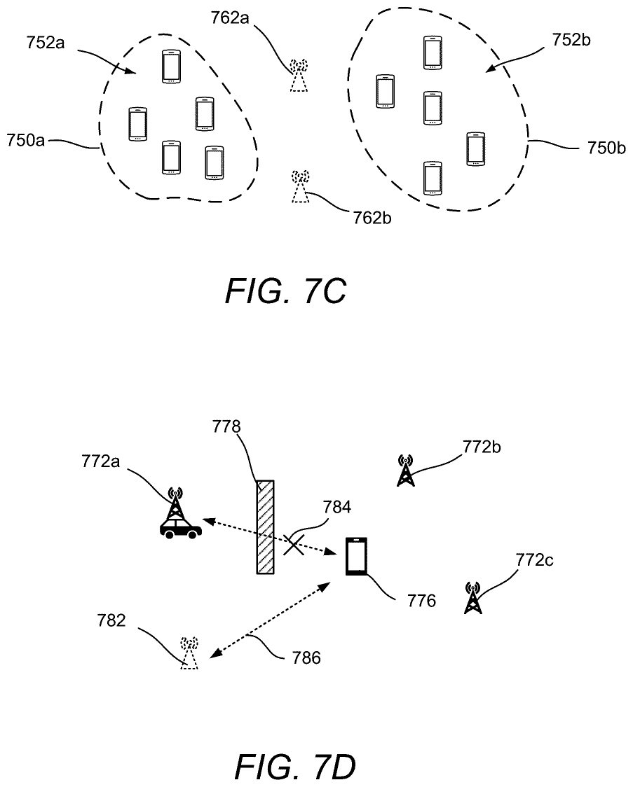

In some aspects, the identifying the set of candidate anchor locations may be based on a distribution pattern for improving a GDOP of the position estimation of the one or more target nodes. FIGS. 7A-7D show various examples of candidate anchor locations with respect to a target node, according to aspects of the disclosure.

According to the example shown in FIG. 7A, in some aspects, if all candidate anchor nodes 712a, 712b, and 712c for a target node 716 are to one side of the target node 716, a candidate anchor location 722 may be on the other side of the target node 716. In some aspects, the sides may correspond to above, below, or any given direction. For example, the network entity, UE, or TRP or base station that performs operation 620 may identify a region 710 that encompasses the set of candidate anchor nodes 712a, 712b, and 712c, and identify a reference point 714 of the region 710. The network entity, UE, or TRP or base station that performs operation 620 may identify a candidate anchor location 722 that is at an opposite side of the reference point 714 with respect to the target node 716.

According to the example shown in FIG. 7B, in some aspects, if all candidate anchor nodes 732a, 732b, 732c, and 732d for a target node 736 are to one side of the target node 736, a candidate anchor location 742 may be at a distance or height with respect to the target node 736 different from that of the candidate anchor nodes 732a, 732b, 732c, and 732d collectively. In some aspects, adding drones or elevation-adjustable robot arms as anchor nodes at the candidate anchor locations at different heights may improve vertical positioning accuracy. For example, the network entity, UE, or TRP or base station that performs operation 620 may identify a region 730 that encompasses the set of candidate anchor nodes 732a, 732b, 732c, and 732d, and identify a reference point 734 of the region 730. In some examples, the distances between the candidate anchor nodes 732a, 732b, 732c, and 732d and the target node 736 are about the same as a reference distance R1 of the reference point 734 with respect to the target node 736. The network entity, UE, or TRP or base station that performs operation 620 may identify a candidate anchor location 742 that is at a distance R2 different from the reference distance R1 of the reference point 734 with respect to the target node 736.

In some aspects, the identified candidate anchor nodes may include those identified based on FIG. 7A and FIG. 7B.

According to the example shown in FIG. 7C, in some aspects, there may be two clusters of sidelink UEs 752a and 752b (which may, in whole or in part, be identified as candidate anchor nodes) that have good connectivity between any pairs of UEs within each cluster, and the clusters are close to each other but with only a few connections across clusters. In some aspects, it may be desirable to place additional anchor nodes at anchor locations 762a and 762b between the clusters to merge these two clusters 752a and 752b into a single large cluster. For example, the network entity, UE, or TRP or base station that performs operation 620 may identify a first region 750a that encompasses the first cluster 752a of the set of candidate anchor nodes, and identify a second region 750b that encompasses the second cluster 752b of the set of candidate anchor nodes. The network entity, UE, or TRP or base station that performs operation 620 may identify at least one of candidate anchor locations 762a and 762b between the first region 750a and the second region 750b for placing anchor nodes.

According to the example shown in FIG. 7D, in some aspects, the set of candidate anchor nodes may include anchor nodes 772a, 772b, and 772c for a positioning estimation procedure for target node 776. It may be desirable to move a potential anchor node (e.g., anchor node 772a that is movable) to be clear of a known blockage 778 in the direct path 784 between the anchor node 772a and the target node 776. For example, the network entity, UE, or TRP or base station that performs operation 620 may identify one of the set of candidate anchor nodes 772a that has no line-of-sight path 784 to the target node 776. The network entity, UE, or TRP or base station that performs operation 620 may identify a candidate anchor location 782 based on the mobility capability of the candidate anchor node 772a, where the identified candidate anchor location 782 has a line-of-sight path 786 to the target node 786.

Referring back to FIG. 6, after operation 620, the method 600 may proceed to operation 625. At operation 625, the network entity, UE, or TRP or base station determines, based on at least movability capability of the candidate anchor nodes, whether to modify the set of candidate anchor nodes in view of the set of candidate anchor locations or whether to modify the set of candidate anchor locations in view of the set of candidate anchor nodes. For example, if none of the candidate anchor nodes is movable or suitable to be moved to a corresponding one of the candidate anchor locations, either the set of candidate anchor nodes or the set of candidate anchor locations may be modified, and the method 600 may proceed to operation 610 or 620 (path YES) in order to ensure consistency of the set of candidate anchor nodes and the set of candidate anchor locations. Otherwise, the method 600 may proceed to operation 630 (path NO).

For example, as shown in FIGS. 7A and 7B, if there is no movable anchor node or no anchor node that has the mobility capability to be moved to the identified anchor location(s) 722 or 742, the set of candidate anchor nodes may be updated (e.g., the method 600 proceeds to repeat operation 610) in order to pick an anchor node for the anchor location, even if such new anchor node may be suboptimal on other metrics such as RSRP. In some aspects, if no anchor node is available to be moved to the identified anchor locations, the method 600 may proceed to repeat operation 620 in order to update the candidate anchor locations to reconcile the candidate anchor nodes with the limitations of movability of the anchor nodes.

In some aspects, operation 625 may be performed by the one or more network transceivers 390, the one or more processors 394, memory 396, and/or anchor placement component 398, any or all of which may be considered means for performing operation 625. In some aspects, operation 625 may be performed by the one or more WWAN transceivers 310, the one or more processors 332, memory 340), and/or anchor placement component 342, any or all of which may be considered means for performing operation 625. In some aspects, operation 625 may be performed by the one or more WWAN transceivers 350), the one or more processors 384, memory 386, and/or anchor placement component 388, any or all of which may be considered means for performing operation 625.

In some aspects, the method 600 may include one or more iterations of operations 610, 620, and 625. In some aspects, the network entity, UE, or TRP or base station that performs method 600 may ignore the possible inconsistency between the set of candidate anchor nodes and the set of candidate anchor locations, and operation 625 may be omitted.

At operation 630, the network entity, UE, or TRP or base station instructs at least a subset of the set of candidate anchor nodes to move based on the set of candidate anchor locations. In some aspects, the network entity, UE, or TRP or base station that performs operation 630) may determine which anchors nodes to be moved based on the set of candidate anchor locations, the location information of the set of candidate anchor nodes, and/or the mobility capability of the set of candidate anchor nodes.

In some aspects, operation 630 may be performed by the one or more network transceivers 390, the one or more processors 394, memory 396, and/or anchor placement component 398, any or all of which may be considered means for performing operation 630. In some aspects, operation 630 may be performed by the one or more WWAN transceivers 310, the one or more processors 332, memory 340), and/or anchor placement component 342, any or all of which may be considered means for performing operation 630. In some aspects, operation 630 may be performed by the one or more WWAN transceivers 350, the one or more processors 384, memory 386, and/or anchor placement component 388, any or all of which may be considered means for performing operation 630.

In one example, anchor nodes that are currently in undesirable locations (as based on the set of candidate anchor locations) may be moved to corresponding candidate anchor locations determined for these anchor nodes. In one example, for a candidate anchor location that is identified not for any particular anchor node, an anchor node from the set of candidate anchor nodes that is willing and able to be moved may be selected to move to such anchor location. In some aspects, the selection may be based on multiple criteria, including whether the selected anchor node is already planned for use at its current location, whether the movement of the selected anchor node affects the planned use, and/or whether another node can be used to take the anchor location, considering the route, the distance, and/or the time taken for another anchor to reach the anchor location.

After identifying the anchor nodes to be moved and the corresponding candidate anchor locations, the network entity, UE, or TRP or base station may command or instruct the anchor nodes to move to the corresponding candidate anchor locations. In some aspects, the network entity, UE, or TRP or base station that performs operation 630 may determine one or more moving plans of moving respective one or more of the set of candidate anchor nodes based on the set of candidate anchor locations. The network entity, UE, or TRP or base station that performs operation 630 may determine priority of the one or more moving plans based on factors including: impact of the one or more of the set of candidate anchor nodes to precision of the positioning the target node, collision avoidance of the one or more moving plans (e.g., in an IIoT scenario), or a combination thereof. The network entity, UE, or TRP or base station that performs operation 630 may determine, based on the priority, an execution sequence of the one or more moving plans or omission of a portion of the one or more moving plans.

At operation 635, the network entity, UE, or TRP or base station determines whether moving the subset of the set of candidate anchor nodes as instructed at 630 failed. In some aspects, operation 635 may be performed by the one or more network transceivers 390, the one or more processors 394, memory 396, and/or anchor placement component 398, any or all of which may be considered means for performing operation 635. In some aspects, operation 635 may be performed by the one or more WWAN transceivers 310, the one or more processors 332, memory 340, and/or anchor placement component 342, any or all of which may be considered means for performing operation 635. In some aspects, operation 635 may be performed by the one or more WWAN transceivers 350, the one or more processors 384, memory 386, and/or anchor placement component 388, any or all of which may be considered means for performing operation 635.

In some aspects, the network entity, UE, or TRP or base station that performs operation 635 may receive an indication from a candidate anchor node of the subset of the set of candidate anchor nodes, where the indication may indicate whether moving the candidate anchor node based on the set of candidate anchor locations by a positioning time scheduled for performing the positioning estimation procedure of the one or more target nodes is successful. Based on the indication indicating that the moving the candidate anchor node by the positioning time is not successful, the method 600 may proceed to operation 610 or 620 to update the set of candidate anchor nodes, the set of candidate anchor locations, or a combination thereof (path YES). In some aspects, based on the indication indicating that the moving the candidate anchor node by the positioning time is not successful, the method 600 may proceed to operation 630 to execute an alternative or backup set of moving plans without going back to operation 610 or 620 (path YES). Otherwise, the method 600 may proceed to operation 640 (path NO).

In some aspects, the instructed movement of the candidate anchor nodes may be confirmed by various approaches, such as based on an external control system, or based on whether an AGV reaches a particular charging dock or other sensors installed in the environment. In some aspects, operation 635 may be performed after operation 640, where the success or failure of the moving plan may be confirmed based on measurements from positioning operations (e.g., based on reception/transmission of reference signals for positioning) performed with the anchor nodes.

In some aspects, the method 600 may include one or more iterations of operations 610, 620, 630, and/or 635. In some aspects, the network entity, UE, or TRP or base station that performs method 600 may ignore the possible failure of the moving of the candidate anchor nodes, and operation 635 may be omitted.

At operation 640, the network entity, UE, or TRP or base station configures the set of candidate anchor nodes and the one or more target nodes to engage in positioning operations at the positioning time to determine a position estimation of the one or more target nodes. In some aspects, operation 640 may be performed by the one or more network transceivers 390, the one or more processors 394, memory 396, and/or anchor placement component 398, any or all of which may be considered means for performing operation 640. In some aspects, operation 640 may be performed by the one or more WWAN transceivers 310, the one or more processors 332, memory 340, and/or anchor placement component 342, any or all of which may be considered means for performing operation 640. In some aspects, operation 640 may be performed by the one or more WWAN transceivers 350, the one or more processors 384, memory 386, and/or anchor placement component 388, any or all of which may be considered means for performing operation 640.

In some aspects, a portion or all of the anchor nodes and/or the one or more target nodes may be configured as transmitting and/or receiving nodes for positioning reference signals (e.g., PRS) based on one or more positioning methods including a TDOA based positioning method, an RTT based positioning method, an AoD based method, or any combination thereof. The measurement reports of the positioning reference signals may be processed by a server (e.g., a UE-assisted positioning procedure processed by an LMF), the target node (e.g., a UE-based positioning procedure processed by the target node), or a wireless device other than the target node (e.g., a sidelink positioning procedure processed by a SL-UE). In some aspects, a network entity (e.g., LMF) may schedule the positioning reference signal transmissions at a future positioning time at which the positioning operations will be performed. In some aspects, the future positioning time may account for the time needed for movement and placement of the candidate anchor nodes at operation 630.

In some aspects, when periodic or repeated positioning estimation procedures are performed, operations of the method 600 may be performed recursively. In some aspects, the moving plans of the anchor nodes may be planed ahead considering the anchor locations for one or more subsequent repetitions of method 600.

In one example, the configuring the set of candidate anchor nodes and the one or more target nodes to engage in the positioning operations at the positioning time to determine the position estimation of the one or more target nodes may include configuring the one or more target nodes to perform a first position estimation procedure of a target node (e.g., a UE-based positioning procedure). In another example, the configuring the set of candidate anchor nodes and the one or more target nodes to engage in the positioning operations at the positioning time to determine the position estimation of the one or more target nodes may include configuring a target node to transmit first measurement reports to a server or at least one anchor node of the set of candidate anchor nodes to transmit second measurement reports to the server, the first measurement reports or the second measurement reports enabling the server to perform a second position estimation procedure of the target node (e.g., a UE-assisted positioning procedure). In yet another example, the configuring the set of candidate anchor nodes and the one or more target nodes to engage in the positioning operations at the positioning time to determine the position estimation of the one or more target nodes may include configuring a target node to transmit reference signals to another target node, receive reference signals from the other target node, transmit third measurement reports to the other target node, or a combination thereof, where the reference signals or the third measurement reports enable the other target node to perform a third position estimation procedure of the target node (e.g., a sidelink positioning procedure).

In one example, the configuring the set of candidate anchor nodes and the one or more target nodes to engage in the positioning operations at the positioning time to determine the position estimation of the one or more target nodes may include a combination of the UE-based positioning procedure, the UE-assisted positioning procedure, and/or the sidelink positioning procedure.

In one example, the network entity, UE, or TRP or base station that performed operation 640) may receive, from the one or more target nodes or at least one anchor node of the set of candidate anchor nodes, measurement reports including measurements of wireless signals between the one or more target nodes and the at least one anchor node of the set of candidate anchor nodes (e.g., based on reception/transmission of reference signals for positioning). The network entity, UE, or TRP or base station that performed operation 640 (e.g., a location server) may determine the position estimation of the one or more target nodes based, at least in part, on the measurement reports.

Moreover, given the potentially dynamic situation with the placement of the anchor nodes being adjustable and/or controllable, reports of measurements and indications of intended transmissions may be tagged with a timestamp and/or other identification information that indicate the information about the positions of the nodes involved in those measurements/transmissions. In some aspects, the information about the positions of the nodes may include an absolute position or a relative position, with or without uncertainty information. The relative position may be relative to other nodes or to a previous location (at a previous timestamp and/or location ID) of the same node.

In one example, the configuring the set of candidate anchor nodes and the one or more target nodes to engage in the positioning operations at the positioning time to determine the position estimation of the one or more target nodes may include configuring a target node to transmit first measurement reports to a server or at least one anchor node of the set of candidate anchor nodes to transmit second measurement reports to the server. At least one measurement report of the first measurement reports or the second measurement reports may include a timestamp, information about a position of the target node or an anchor node that is involved in a reported measurement included in the at least one measurement report, or both.

In some aspects, operations 620, 630, and 640 may be configured to move one anchor node to create several virtual anchor nodes in order to improve the GDOP. In some aspects, the method 600 may further include moving one of the one or more target nodes in order to improve the positioning in accuracy.

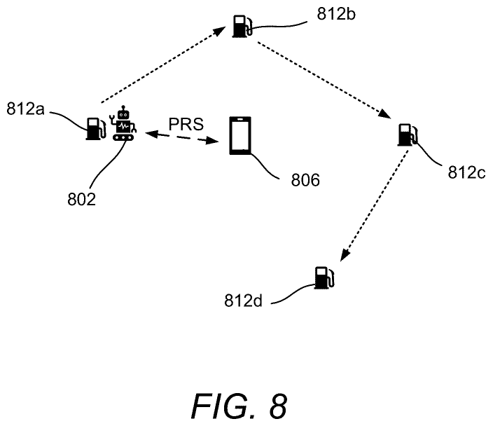

FIG. 8 shows an example of moving a physical anchor node to create multiple virtual anchor nodes, according to aspects of the disclosure. In some aspects, the set of candidate anchor nodes may include only one anchor node, and the set of candidate anchor locations may include a plurality of anchor locations that the anchor node is to be placed at different time points. In some aspects, while the set of candidate anchor nodes may include multiple anchor nodes, one or more anchor nodes may still be used to create new virtual anchor nodes.

In some aspects, as shown in FIG. 8, the positioning estimation procedure of a target node may be performed based on measurements collected across multiple moves of one or more anchor nodes (e.g., based on reception/transmission of reference signals for positioning). For example, when a single anchor node 802 (such as an AGV) for a target node 806 moves to multiple known anchor locations 812a, 812b, 812c, and 812d and makes PRS transmission and/or reception at each of the anchor locations, these PRS transmission and/or reception at the anchor locations effectively render the single anchor node as multiple virtual anchor nodes at the anchor locations. In the example shown in FIG. 8, the anchor locations 812a, 812b, 812c, and 812d may correspond to charging stations for the AGV 802, and the AGV 802 may be used as an anchor node for the target node 806. The AGV 802 may access the charging stations at anchor locations 812a, 812b, 812c, and 812d and perform PRS transmission and/or reception at each of the charging stations. Within a positioning window (e.g., a measurement gap, PRS instances, a processing window without measurement gap), when the target node 806 may be considered as at the same location or without substantial movement, the AGV 802 may effectively function as a virtual anchor node at each of the charging stations.

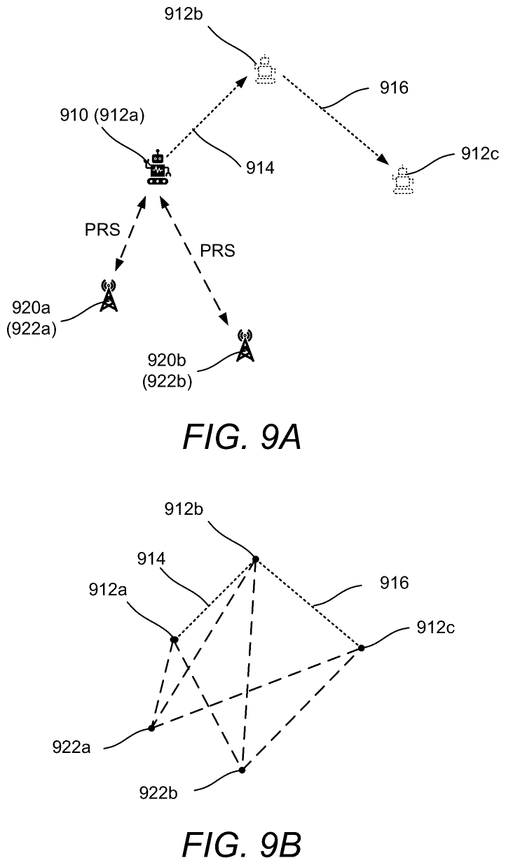

FIGS. 9A and 9B show an example of moving a target node to work with only a limited amount of anchor nodes, according to aspects of the disclosure. In some aspects, the target node may move or be instructed to move, from an initial position, to one or more other positions at one or more respective time points. The relative positions of the target node may be obtained based on one or more relative movements performed by the target node. The position estimation of the target node may be based on ranging, angle, and/or timing measurements of the wireless target node at various positions with respect to the anchor nodes, the known locations of the anchor nodes, and information of the relative positions.

In some aspects, as shown in FIG. 9A, the positioning estimation procedure of the target node 910 may be performed based on the target node movement, where the target node 910 (e.g., an AGV) may move to multiple positions 912a, 912b, and 912c, and the relative positions of the target node between positions 912a, 912b, and 912c may be obtained based on relative movement performed by the target node. The target node may perform reception of reference signals, transmission of reference signals, measurements of reference signals, or a combination thereof at each of the multiple positions 912a, 912b, and 912c. This may enable the positioning estimation procedure to have an improved accuracy with same or less anchor nodes.

For example, when a positioning estimate of an AGV 910 (as a target node) is to be determined, but only a limited number of anchor nodes are available (e.g., two anchor nodes, including anchor node 920a at location 922a and anchor node 920b at location 922b). In this example, the AGV 910 may know its position relative to its past positions (e.g., relative movements 914 and 916) with sufficient accuracy based on one or more sensors installed on the AGV 910, such as odometer and/or steering angle. The AGV 910 may move to different positions 912a. 912b, and 912c, and perform ranging measurements, angle measurements, timing measurements, or a combination thereof, at each of the positions 912a, 912b, and 912c. Such movements may include horizontal and/or vertical movements.

As shown in FIG. 9B, as a non-limiting example, using a multi-dimensional scaling (MDS) algorithm, the coordinates of the positions 912a, 912b, and 912c may be determined based on the relative positions between the positions 912a, 912b, and 912c (e.g., the relative movements 914 and 916 performed by the target node) and the relative ranging or positioning measurements between the AGV 910 at different positions 912a, 912b, and 912c with respect to the anchor nodes 920a and 920b at anchor locations 922a and 922b. Of course, in some examples, the relative ranging or positioning measurements may be performed based on an algorithm different from the MDS algorithm. Accordingly, the motion of the AGV 910 may create spatial diversity for the positioning estimation procedure. In some examples, the ranging or positioning measurements between the AGV 910 and the anchor nodes 920a and 920b may include ranging based on PRS and/or RTT measurements, angle (AoA/AoD) measurements, time difference measurements, or a combination of both. In some aspects, even when a single position of the target node may be enough with only a single anchor node, using multiple positions of the target node may further increase the positioning accuracy.

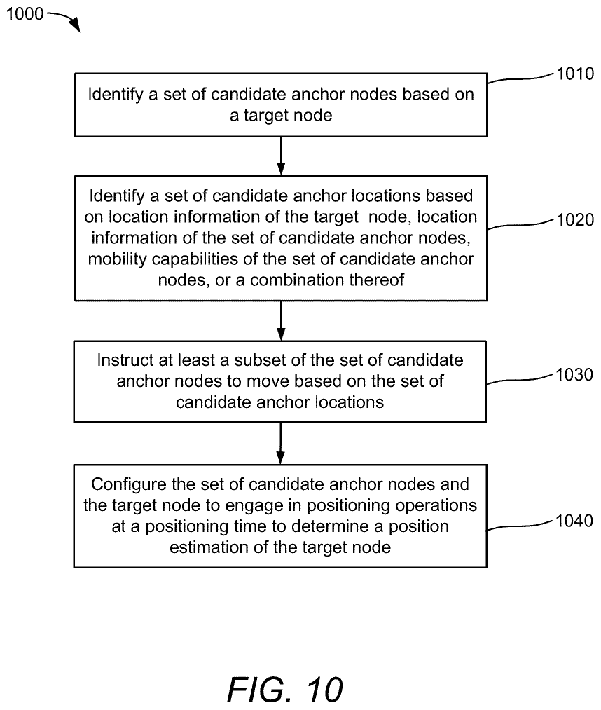

FIG. 10 illustrates an example method 1000 of positioning a target node, according to aspects of the disclosure. In some aspects, method 1000 may be performed by one or more processing devices, such as a network entity (e.g., any of the network entity, LMF, SLP, or server described herein), a UE (e.g., any of the UE described herein), or a TRP or base station (e.g., any of the TRP or base station described herein).

At 1010, the one or more processing devices identify a set of candidate anchor nodes based on the target node, such as operation 610 based on the conditions and factors illustrated with respect to FIG. 6. In some aspects, operation 1010 may be performed by the one or more network transceivers 390, the one or more processors 394, memory 396, and/or anchor placement component 398, any or all of which may be considered means for performing operation 1010. In some aspects, operation 1010 may be performed by the one or more WWAN transceivers 310, the one or more processors 332, memory 340, and/or anchor placement component 342, any or all of which may be considered means for performing operation 1010. In some aspects, operation 1010 may be performed by the one or more WWAN transceivers 350, the one or more processors 384, memory 386, and/or anchor placement component 388, any or all of which may be considered means for performing operation 1010.

At 1020, the one or more processing devices identify a set of candidate anchor locations based on at least location information of the target node, location information of the set of candidate anchor nodes, mobility capabilities of the set of candidate anchor nodes, or a combination thereof. In some aspects, operation 1020 may correspond to operation 620 as illustrated with respect to FIG. 6. In some aspects, operation 1020 may be performed by the one or more network transceivers 390, the one or more processors 394, memory 396, and/or anchor placement component 398, any or all of which may be considered means for performing operation 1020. In some aspects, operation 1020 may be performed by the one or more WWAN transceivers 310, the one or more processors 332, memory 340, and/or anchor placement component 342, any or all of which may be considered means for performing operation 1020. In some aspects, operation 1020 may be performed by the one or more WWAN transceivers 350, the one or more processors 384, memory 386, and/or anchor placement component 388, any or all of which may be considered means for performing operation 1020.

At 1030, the one or more processing devices instruct at least a subset of the set of candidate anchor nodes to move based on the set of candidate anchor locations. In some aspects, operation 1030 may correspond to operation 630 as illustrated with respect to FIG. 6. In some aspects, operation 1030 may be performed by the one or more network transceivers 390, the one or more processors 394, memory 396, and/or anchor placement component 398, any or all of which may be considered means for performing operation 1030. In some aspects, operation 1030 may be performed by the one or more WWAN transceivers 310, the one or more processors 332, memory 340, and/or anchor placement component 342, any or all of which may be considered means for performing operation 1030. In some aspects, operation 1030 may be performed by the one or more WWAN transceivers 350, the one or more processors 384, memory 386, and/or anchor placement component 388, any or all of which may be considered means for performing operation 1030.

At 1040, the one or more processing devices configure the set of candidate anchor nodes and the target node to engage in positioning operations at the positioning time to determine a position estimation of the target node. In some aspects, operation 1040 may correspond to operation 640 as illustrated with respect to FIG. 6. In some aspects, operation 1040 may be performed by the one or more network transceivers 390, the one or more processors 394, memory 396, and/or anchor placement component 398, any or all of which may be considered means for performing operation 1040. In some aspects, operation 1040 may be performed by the one or more WWAN transceivers 310, the one or more processors 332, memory 340, and/or anchor placement component 342, any or all of which may be considered means for performing operation 1040. In some aspects, operation 1040 may be performed by the one or more WWAN transceivers 350, the one or more processors 384, memory 386, and/or anchor placement component 388, any or all of which may be considered means for performing operation 1040.

As will be appreciated, a technical advantage of the method 1000 is to determine and control placement and/or movement of anchor nodes and/or the target node and instruct the anchor nodes and/or the target node to move accordingly in order to improve positioning performance and/or accuracy of the estimated position for the target node. In some aspects, the placement and movement may be for improving GDOP, for creating virtual anchor nodes, for creating spatial diversity, or any combination thereof.

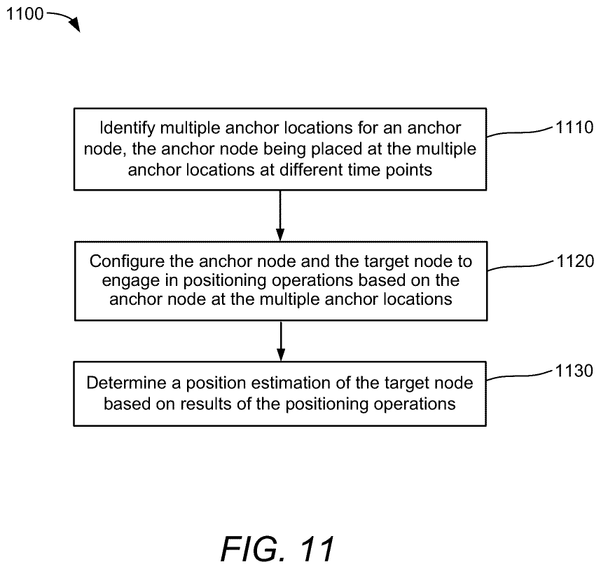

FIG. 11 illustrates another example method 1100 of positioning a target node, according to aspects of the disclosure. In some aspects, method 1100 may correspond to the example as shown with reference to FIG. 8, and the target node may correspond to the target node 806 in FIG. 8. In some aspects, method 1100 may be performed by one or more processing devices, such as a network entity (e.g., any of the network entity, LMF, SLP, or server described herein), a UE (e.g., any of the UE described herein), or a TRP or base station (e.g., any of the TRP or base station described herein).

At operation 1110, the one or more processing devices identify multiple anchor locations for an anchor node, the anchor node being placed at the multiple anchor locations at different time points. For example, an anchor node (e.g., the AGV 802) may move, or be instructed to move, to multiple known anchor locations 812a, 812b, 812c, and 812d. In the example shown in FIG. 8, the anchor locations 812a, 812b, 812c, and 812d may correspond to charging stations for the AGV 802. The network entity, the UE (e.g. the target node itself or a neighboring UE), or the TRP or the base station may obtain the information regarding the anchor locations 812a, 812b, 812c, and 812d.

In some aspects, operation 1110 may be performed by the one or more network transceivers 390, the one or more processors 394, memory 396, and/or anchor placement component 398, any or all of which may be considered means for performing operation 1110. In some aspects, operation 1110 may be performed by the one or more WWAN transceivers 310, the one or more processors 332, memory 340, and/or anchor placement component 342, any or all of which may be considered means for performing operation 1110. In some aspects, operation 1110 may be performed by the one or more WWAN transceivers 350, the one or more processors 384, memory 386, and/or anchor placement component 388, any or all of which may be considered means for performing operation 1110.

At operation 1120, the one or more processing devices configure the anchor node and the target node to engage in positioning operations based on the anchor node at the multiple anchor locations. For example, the network entity, the UE (e.g. the target node itself or a neighboring UE), or the TRP or the base station may configure the anchor node (e.g., the AGV 802) and/or the target node (e.g., the target node 806) to make PRS transmission and/or reception when the anchor node is at each of the anchor locations. In some aspects, the positioning operations may include performing ranging measurements, angle measurements, timing measurements, or a combination thereof, between the target node and the anchor node based on one or more positioning reference signals between the target node and the anchor node. These PRS transmission and/or reception at the anchor locations effectively render the single anchor node as multiple virtual anchor nodes at the anchor locations. In some aspects, the positioning operations may be based on ranging or positioning measuring processes between the AGV 802 and the target node 806, including ranging based on PRS and/or RTT measurements, angle (AoA/AoD) measurements, or a combination of both.

In some aspects, operation 1120 may be performed by the one or more network transceivers 390, the one or more processors 394, memory 396, and/or anchor placement component 398, any or all of which may be considered means for performing operation 1120. In some aspects, operation 1120 may be performed by the one or more WWAN transceivers 310, the one or more processors 332, memory 340, and/or anchor placement component 342, any or all of which may be considered means for performing operation 1020. In some aspects, operation 1120 may be performed by the one or more WWAN transceivers 350, the one or more processors 384, memory 386, and/or anchor placement component 388, any or all of which may be considered means for performing operation 1120.

At operation 1130, the one or more processing devices determine a position estimation of the target node based on results of the positioning operations. Within a positioning window (e.g., a measurement gap, PRS instances, a processing window without measurement gap), when the target node 806 may be considered as at the same location or without substantial movement, the AGV 802 may effectively function as a virtual anchor node at each of the charging stations. As such, in some examples, the network entity, the UE (e.g. the target node itself or a neighboring UE), or the TRP or the base station may determine the estimate position of the target node by using the anchor node at different anchor locations as different virtual anchor nodes.

In some aspects, operation 1130 may be performed by the one or more network transceivers 390, the one or more processors 394, memory 396, and/or anchor placement component 398, any or all of which may be considered means for performing operation 1130. In some aspects, operation 1130 may be performed by the one or more WWAN transceivers 310, the one or more processors 332, memory 340, and/or anchor placement component 342, any or all of which may be considered means for performing operation 1130. In some aspects, operation 1130 may be performed by the one or more WWAN transceivers 350, the one or more processors 384, memory 386, and/or anchor placement component 388, any or all of which may be considered means for performing operation 1130.

As will be appreciated, a technical advantage of the method 1100 is to utilize the relative movement between a target node and an anchor node in order to improve positioning performance and/or accuracy of the estimated position for the target node. In some aspects, the multiple anchor locations of the anchor node may be known, and multiple anchor locations may create spatial diversity (e.g., by effectively creating virtual anchor nodes) for increasing the accuracy of the positioning estimation procedure. In some aspects, with a number of physical anchor nodes meeting a minimum number of anchors required by a positioning procedure, the creation of the virtual anchor nodes may improve the positioning accuracy. In some aspects, with a number of physical anchor nodes failing to meet a minimum number of anchors required by a positioning procedure, the creation of the virtual anchor nodes may enable the execution of the positioning procedure.

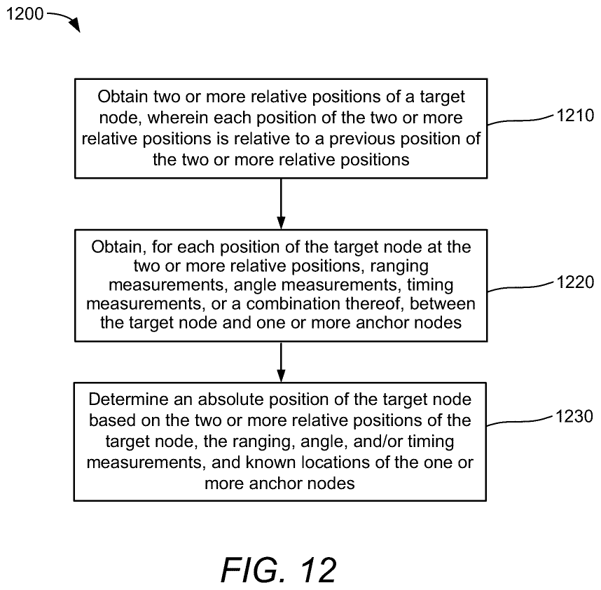

FIG. 12 illustrates yet another example method 1200 of positioning a target node, according to aspects of the disclosure. In some aspects, method 1200 may correspond to the example as shown with reference to FIGS. 9A and 9B, and the target node may correspond to the AGV 910 in FIG. 9A. In some aspects, method 1200 may be performed by one or more processing devices, such as a network entity (e.g., any of the network entity, LMF, SLP, or server described herein), a UE (e.g., any of the UE described herein), or a TRP or base station (e.g., any of the TRP or base station described herein).

At operation 1210, the one or more processing devices obtain two or more relative positions of the target node, wherein each position of the two or more relative positions is relative to a previous position of the two or more relative positions. For example, the target node (e.g., the AGV 910) may move, or be instructed to move, from an initial position 912a to position 912b, and to position 912c. The network entity, the UE (e.g. the target node itself or a neighboring UE), or the TRP or the base station may obtain the information regarding the relative positions between positions 912a and 912b and between positions 912b and 912c, such as based on the relative movements 914 and 916 as shown in FIGS. 9A and 9B. In some aspects, the one or more relative movements may be determined based on one or more sensors installed on the target node.

In some aspects, operation 1210 may be performed by the one or more network transceivers 390, the one or more processors 394, memory 396, and/or anchor placement component 398, any or all of which may be considered means for performing operation 1210. In some aspects, operation 1210 may be performed by the one or more WWAN transceivers 310, the one or more processors 332, memory 340, and/or anchor placement component 342, any or all of which may be considered means for performing operation 1210. In some aspects, operation 1210 may be performed by the one or more WWAN transceivers 350, the one or more processors 384, memory 386, and/or anchor placement component 388, any or all of which may be considered means for performing operation 1210.

At operation 1220, the one or more processing devices obtain, for each position of the target node at the two or more relative positions, ranging measurements, angle measurements, timing measurements, or a combination thereof, between the target node and one or more anchor nodes. For example, the network entity, the UE (e.g. the target node itself or a neighboring UE), or the TRP or the base station may obtain ranging, angle, and/or timing measurements of the target node (e.g., the AGV 910) with respect to the anchor nodes 920a and 920b when the target node is at respective one of the positions 912a, 912b, and 912c. In some aspects, the ranging, angle, and/or timing measurements may be determined based on ranging or positioning measuring processes between the AGV 910 and the anchor nodes 920a and 920b, including ranging based on PRS and/or RTT measurements, angle (AoA/AoD) measurements, or a combination of both.

In some aspects, operation 1220 may be performed by the one or more network transceivers 390, the one or more processors 394, memory 396, and/or anchor placement component 398, any or all of which may be considered means for performing operation 1220. In some aspects, operation 1220 may be performed by the one or more WWAN transceivers 310, the one or more processors 332, memory 340, and/or anchor placement component 342, any or all of which may be considered means for performing operation 1020. In some aspects, operation 1220 may be performed by the one or more WWAN transceivers 350, the one or more processors 384, memory 386, and/or anchor placement component 388, any or all of which may be considered means for performing operation 1220.

At operation 1230, the one or more processing devices determine an absolute position of the target node based on the two or more relative positions of the target node, the ranging measurements, angle measurements, timing measurements, or a combination thereof, and known locations of the one or more anchor nodes. For example, the network entity, the UE (e.g. the target node itself or a neighboring UE), or the TRP or the base station may determine the absolute position of at least one of the positions 912a, 912b, and 912c based on the two or more relative positions of the target node, the obtained ranging, angle, and/or timing measurements, and the known locations of the one or more anchor nodes 920a and 920b. In some aspects, the absolute position may be determined based on a multi-dimensional scaling (MDS) algorithm.

In some aspects, operation 1230 may be performed by the one or more network transceivers 390, the one or more processors 394, memory 396, and/or anchor placement component 398, any or all of which may be considered means for performing operation 1230. In some aspects, operation 1230 may be performed by the one or more WWAN transceivers 310, the one or more processors 332, memory 340, and/or anchor placement component 342, any or all of which may be considered means for performing operation 1230. In some aspects, operation 1230 may be performed by the one or more WWAN transceivers 350, the one or more processors 384, memory 386, and/or anchor placement component 388, any or all of which may be considered means for performing operation 1230.

As will be appreciated, a technical advantage of the method 1200 is to utilize the relative movement between a target node and one or more anchor nodes in order to improve positioning performance and/or accuracy of the estimated position for the target node. In some aspects, the relative positions of the target node may be obtained with sufficient accuracy from the sensors installed on the target node, and such relative positions may create spatial diversity for increasing the accuracy of the positioning estimation procedure.

In some aspects, a positioning estimation procedure of a target node may be performed based on a combination of method 600, 1000, 1100, and/or 1200. For example, a positioning estimation procedure of a target node may be performed based on multiple anchor nodes, where at least a portion of the anchor nodes may be used based on the method 600 or 1000, at least a portion of the anchor nodes may be used based on the method 1100, the target node may be movable based on the method 1200, or a combination thereof, in order to improve spatial diversity between the target node and the anchor nodes for increasing the accuracy of the positioning estimation procedure.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of positioning a target node, comprising: identifying a set of candidate anchor nodes based on the target node: identifying a set of candidate anchor locations based on location information of the target node, location information of the set of candidate anchor nodes, mobility capabilities of the set of candidate anchor nodes, or a combination thereof: instructing at least a subset of the set of candidate anchor nodes to move based on the set of candidate anchor locations: and configuring the set of candidate anchor nodes and the target node to engage in positioning operations at a positioning time to determine a position estimation of the target node.

Clause 2. The method of clause 1, wherein the location information of the target node indicates a coarse location of the target node.

Clause 3. The method of any of clauses 1 to 2, wherein the identifying the set of candidate anchor locations is based on a distribution pattern for improving a geometric dilution of precision (GDOP) of the position estimation of the target node.

Clause 4. The method of clause 3, wherein the identifying the set of candidate anchor locations comprises: identifying a region that encompasses the set of candidate anchor nodes: identifying a reference point of the region: and identifying one of the set of candidate anchor locations that is at an opposite side of the reference point with respect to the target node, at a distance different from a reference distance of the reference point with respect to the target node, or a combination thereof.

Clause 5. The method of clause 4, further comprising: updating the set of candidate anchor nodes based on at least the identified one of the set of candidate anchor locations that is at the opposite side of the reference point.

Clause 6. The method of clause 3, wherein the identifying the set of candidate anchor locations comprises: identifying a first region that encompasses a first cluster of the set of candidate anchor nodes: identifying a second region that encompasses a second cluster of the set of candidate anchor nodes: and identifying one of the set of candidate anchor locations that is between the first region and the second region.

Clause 7. The method of clause 6, further comprising: updating the set of candidate anchor nodes based on at least the identified one of the set of candidate anchor locations that is between the first region and the second region.

Clause 8. The method of clause 3, wherein the identifying the set of candidate anchor locations comprises: identifying one of the set of candidate anchor nodes that has no line-of-sight path to the target node: and identifying one of the set of candidate anchor locations based on the mobility capability of the one of the set of candidate anchor nodes, the identified one of the candidate anchor locations has a line-of-sight path to the target node.

Clause 9. The method of any of clauses 1 to 8, further comprising: receiving an indication from a candidate anchor node of the subset of the set of candidate anchor nodes, the indication indicating whether moving the candidate anchor node based on the set of candidate anchor locations by the positioning time is successful: and based on the indication indicating that the moving the candidate anchor node by the positioning time is not successful, updating the set of candidate anchor nodes, the set of candidate anchor locations, or a combination thereof.

Clause 10. The method of any of clauses 1 to 9, wherein the identifying the set of candidate anchor locations is performed based on an estimated geometric dilution of precision (GDOP) of the position estimation of the target node, node types of the set of candidate anchor nodes, a network topology of the set of candidate anchor nodes, a line-of-sight condition, or a combination thereof.

Clause 11. The method of any of clauses 1 to 10, wherein the identifying the set of candidate anchor nodes is performed based on one or more last recorded positions of the target node, one or more established communication connections with the target node, one or more signal strengths of signals measured by the target node, an estimated geometric dilution of precision (GDOP) of the position estimation of the target node, node types of the set of candidate anchor nodes, node capabilities of the set of candidate anchor nodes, or a combination thereof.

Clause 12. The method of any of clauses 1 to 11, wherein the identifying the set of candidate anchor nodes is performed based on one or more suggested anchor nodes provided by the target node.

Clause 13. The method of any of clauses 1 to 12, further comprising: determining one or more moving plans of moving respective one or more of the set of candidate anchor nodes based on the set of candidate anchor locations: determining priority of the one or more moving plans based on impact of the one or more of the set of candidate anchor nodes to precision of the positioning the target node, collision avoidance of the one or more moving plans, or a combination thereof: determining, based on the priority, an execution sequence of the one or more moving plans or omission of a portion of the one or more moving plans.

Clause 14. The method of any of clauses 1 to 13, wherein the configuring the set of candidate anchor nodes and the target node to engage in the positioning operations at the positioning time to determine the position estimation of the target node comprises: configuring the target node to perform a first position estimation procedure of the target node: configuring the target node to transmit first measurement reports to a server or at least one anchor node of the set of candidate anchor nodes to transmit second measurement reports to the server, the first measurement reports or the second measurement reports enabling the server to perform a second position estimation procedure of the target node: configuring the target node to transmit reference signals to another target node, receive reference signals from the other target node, transmit third measurement reports to the other target node, or a combination thereof, the reference signals or the third measurement reports enabling the other target node to perform a third position estimation procedure of the target node: or a combination thereof.

Clause 15. The method of any of clauses 1 to 13, wherein the configuring the set of candidate anchor nodes and the target node to engage in the positioning operations at the positioning time to determine the position estimation of the target node comprises: configuring the target node to transmit first measurement reports to a server or at least one anchor node of the set of candidate anchor nodes to transmit second measurement reports to the server, wherein at least one measurement report of the first measurement reports or the second measurement reports includes a timestamp, information about a position of the target node or an anchor node that is involved in a reported measurement included in the at least one measurement report, or both.

Clause 16. The method of any of clauses 1 to 15, further comprising: receiving, from the target node or at least one anchor node of the set of candidate anchor nodes, measurement reports including measurements of wireless signals between the target node and the at least one anchor node of the set of candidate anchor nodes: and determining position estimation of the target node based, at least in part, on the measurement reports.

Clause 17. The method of any of clauses 1 to 16, wherein: the set of candidate anchor locations includes a plurality of anchor locations that at least one anchor node of the set of candidate anchor nodes is to be placed at different time points.

Clause 18. The method of any of clauses 1 to 17, further comprising: obtaining two or more relative positions of the target node, wherein each position of the two or more relative positions is relative to a previous position of the two or more relative positions, wherein the position estimation of the target node is based on ranging measurements, angle measurements, timing measurements, or a combination thereof, between the target node and one or more anchor nodes, the two or more relative positions, and known locations of the one or more anchor nodes.

Clause 19. A method of positioning a target node, comprising: identifying multiple anchor locations for an anchor node, the anchor node being placed at the multiple anchor locations at different time points: configuring the anchor node and the target node to engage in positioning operations based on the anchor node at the multiple anchor locations: and determining a position estimation of the target node based on results of the positioning operations.

Clause 20. The method of clause 19, wherein the anchor node is an automated guided vehicle (AGV), and the anchor locations correspond to locations of charging stations for the AGV.

Clause 21. The method of any of clauses 19 to 20, wherein the positioning operations include performing ranging, angle, and/or timing measurements between the target node and the anchor node based on one or more positioning reference signals between the target node and the anchor node.

Clause 22. A method of positioning a target node, comprising: obtaining two or more relative positions of the target node, wherein each position of the two or more relative positions is relative to a previous position of the two or more relative positions: obtaining, for each position of the target node at the two or more relative positions, ranging measurements, angle measurements, timing measurements, or a combination thereof, between the target node and one or more anchor nodes: and determining an absolute position of the target node based on the two or more relative positions of the target node, the ranging measurements, and known locations of the one or more anchor nodes.

Clause 23. The method of clause 22, further comprising determining the two or more relative positions based on one or more sensors installed on the target node.

Clause 24. The method of any of clauses 22 to 23, wherein the method is performed by: a network server of location management function (LMF), a base station, or the target node.

Clause 25. An apparatus for positioning a target node, comprising: a memory: at least one transceiver: and at least one processor communicatively coupled to the memory and the at least one transceiver, the at least one processor configured to: identify a set of candidate anchor nodes based on the target node: identify a set of candidate anchor locations based on location information of the target node, location information of the set of candidate anchor nodes, mobility capabilities of the set of candidate anchor nodes, or a combination thereof: instruct at least a subset of the set of candidate anchor nodes to move based on the set of candidate anchor locations: and configure the set of candidate anchor nodes and the target node to engage in positioning operations at a positioning time to determine a position estimation of the target node.

Clause 26. The apparatus of clause 25, wherein the location information of the target node indicates a coarse location of the target node.

Clause 27. The apparatus of any of clauses 25 to 26, wherein the set of candidate anchor locations is identified based on a distribution pattern for improving a geometric dilution of precision (GDOP) of the position estimation of the target node.

Clause 28. The apparatus of clause 27, wherein the at least one processor configured to identify the set of candidate anchor locations comprises the at least one processor configured to: identify a region that encompasses the set of candidate anchor nodes; identify a reference point of the region: and identify one of the set of candidate anchor locations that is at an opposite side of the reference point with respect to the target node, at a distance different from a reference distance of the reference point with respect to the target node, or a combination thereof.

Clause 29. The apparatus of clause 28, wherein the at least one processor is further configured to: update the set of candidate anchor nodes based on at least the identified one of the set of candidate anchor locations that is at the opposite side of the reference point.

Clause 30. The apparatus of clause 27, wherein the at least one processor configured to identify the set of candidate anchor locations comprises the at least one processor configured to: identify a first region that encompasses a first cluster of the set of candidate anchor nodes: identify a second region that encompasses a second cluster of the set of candidate anchor nodes: and identify one of the set of candidate anchor locations that is between the first region and the second region.

Clause 31. The apparatus of clause 30, wherein the at least one processor is further configured to: update the set of candidate anchor nodes based on at least the identified one of the set of candidate anchor locations that is between the first region and the second region.

Clause 32. The apparatus of clause 27, wherein the at least one processor configured to identify the set of candidate anchor locations comprises the at least one processor configured to: identify one of the set of candidate anchor nodes that has no line-of-sight path to the target node: and identify one of the set of candidate anchor locations based on the mobility capability of the one of the set of candidate anchor nodes, the identified one of the candidate anchor locations has a line-of-sight path to the target node.

Clause 33. The apparatus of any of clauses 25 to 32, wherein the at least one processor is further configured to: receive, via the at least one transceiver, an indication from a candidate anchor node of the subset of the set of candidate anchor nodes, the indication indicating whether moving the candidate anchor node based on the set of candidate anchor locations by the positioning time is successful: and update, based on the indication indicating that the moving the candidate anchor node by the positioning time is not successful, the set of candidate anchor nodes, the set of candidate anchor locations, or a combination thereof.

Clause 34. The apparatus of any of clauses 25 to 33, wherein the set of candidate anchor locations is identified based on an estimated geometric dilution of precision (GDOP) of the position estimation of the target node, node types of the set of candidate anchor nodes, a network topology of the set of candidate anchor nodes, a line-of-sight condition, or a combination thereof.

Clause 35. The apparatus of any of clauses 25 to 34, wherein the set of candidate anchor nodes is identified based on one or more last recorded positions of the target node, one or more established communication connections with the target node, one or more signal strengths of signals measured by the target node, an estimated geometric dilution of precision (GDOP) of the position estimation of the target node, node types of the set of candidate anchor nodes, node capabilities of the set of candidate anchor nodes, or a combination thereof.

Clause 36. The apparatus of any of clauses 25 to 35, wherein the set of candidate anchor nodes is identified based on one or more suggested anchor nodes provided by the target node.

Clause 37. The apparatus of any of clauses 25 to 36, wherein the at least one processor is further configured to: determine one or more moving plans of moving respective one or more of the set of candidate anchor nodes based on the set of candidate anchor locations; determine priority of the one or more moving plans based on impact of the one or more of the set of candidate anchor nodes to precision of the positioning the target node, collision avoidance of the one or more moving plans, or a combination thereof: determine, based on the priority, an execution sequence of the one or more moving plans or omission of a portion of the one or more moving plans.

Clause 38. The apparatus of any of clauses 25 to 37, wherein the at least one processor configured to configure the set of candidate anchor nodes and the target node to engage in the positioning operations at the positioning time to determine the position estimation of the target node comprises the at least one processor configured to: configure the target node to perform a first position estimation procedure of the target node: configure the target node to transmit first measurement reports to a server or at least one anchor node of the set of candidate anchor nodes to transmit second measurement reports to the server, the first measurement reports or the second measurement reports enabling the server to perform a second position estimation procedure of the target node: configure the target node to transmit reference signals to another target node, receive reference signals from the other target node, transmit third measurement reports to the other target node, or a combination thereof, the reference signals or the third measurement reports enabling the other target node to perform a third position estimation procedure of the target node: or a combination thereof.

Clause 39. The apparatus of any of clauses 25 to 37, wherein the at least one processor configured to configure the set of candidate anchor nodes and the target node to engage in the positioning operations at the positioning time to determine the position estimation of the target node comprises the at least one processor configured to: configure the target node to transmit first measurement reports to a server or at least one anchor node of the set of candidate anchor nodes to transmit second measurement reports to the server, wherein at least one measurement report of the first measurement reports or the second measurement reports includes a timestamp, information about a position of the target node or an anchor node that is involved in a reported measurement included in the at least one measurement report, or both.

Clause 40. The apparatus of any of clauses 25 to 39, wherein the at least one processor is further configured to: receive, via the at least one transceiver, from the target node or at least one anchor node of the set of candidate anchor nodes, measurement reports including measurements of wireless signals between the target node and the at least one anchor node of the set of candidate anchor nodes: and determine position estimation of the target node based, at least in part, on the measurement reports.

Clause 41. The apparatus of any of clauses 25 to 40, wherein: the set of candidate anchor locations includes a plurality of anchor locations that at least one anchor node of the set of candidate anchor nodes is to be placed at different time points.

Clause 42. The apparatus of any of clauses 25 to 41, wherein the at least one processor is further configured to: obtain two or more relative positions of the target node, wherein each position of the two or more relative positions is relative to a previous position of the two or more relative positions, wherein the position estimation of the target node is based on ranging measurements, angle measurements, timing measurements, or a combination thereof, between the target node and one or more anchor nodes, the two or more relative positions, and known locations of the one or more anchor nodes.

Clause 43. An apparatus for positioning a target node, comprising: a memory: at least one transceiver: and at least one processor communicatively coupled to the memory and the at least one transceiver, the at least one processor configured to: identify multiple anchor locations for an anchor node, the anchor node being placed at the multiple anchor locations at different time points: configure the anchor node and the target node to engage in positioning operations based on the anchor node at the multiple anchor locations: and determine a position estimation of the target node based on results of the positioning operations.

Clause 44. The apparatus of clause 43, wherein the anchor node is an automated guided vehicle (AGV), and the anchor locations correspond to locations of charging stations for the AGV.

Clause 45. The apparatus of any of clauses 43 to 44, wherein the positioning operations include performing ranging, angle, and/or timing measurements between the target node and the anchor node based on one or more positioning reference signals between the target node and the anchor node.

Clause 46. An apparatus for positioning a target node, comprising: a memory: at least one transceiver: and at least one processor communicatively coupled to the memory and the at least one transceiver, the at least one processor configured to: obtain two or more relative positions of the target node, wherein each position of the two or more relative positions is relative to a previous position of the two or more relative positions: obtain, for each position of the target node at the two or more relative positions, ranging measurements, angle measurements, timing measurements, or a combination thereof, between the target node and one or more anchor nodes: and determine an absolute position of the target node based on the two or more relative positions of the target node, the ranging measurements, and known locations of the one or more anchor nodes.

Clause 47. The apparatus of clause 46, wherein the at least one processor is further configured to determine the two or more relative positions based on one or more sensors installed on the target node.

Clause 48. The apparatus of any of clauses 46 to 47, wherein the apparatus is: a network server of location management function (LMF), a base station, or the target node.

Clause 49. An apparatus for positioning a target node, comprising: means for identifying a set of candidate anchor nodes based on the target node: means for identifying a set of candidate anchor locations based on location information of the target node, location information of the set of candidate anchor nodes, mobility capabilities of the set of candidate anchor nodes, or a combination thereof: means for instructing at least a subset of the set of candidate anchor nodes to move based on the set of candidate anchor locations: and means for configuring the set of candidate anchor nodes and the target node to engage in positioning operations at a positioning time to determine a position estimation of the target node.

Clause 50. The apparatus of clause 49, wherein the location information of the target node indicates a coarse location of the target node.

Clause 51. The apparatus of any of clauses 49 to 50, wherein the set of candidate anchor locations is identified based on a distribution pattern for improving a geometric dilution of precision (GDOP) of the position estimation of the target node.

Clause 52. The apparatus of clause 51, wherein the means for identifying the set of candidate anchor locations comprises: means for identifying a region that encompasses the set of candidate anchor nodes: means for identifying a reference point of the region; and means for identifying one of the set of candidate anchor locations that is at an opposite side of the reference point with respect to the target node, at a distance different from a reference distance of the reference point with respect to the target node, or a combination thereof.

Clause 53. The apparatus of clause 52, further comprising: means for updating the set of candidate anchor nodes based on at least the identified one of the set of candidate anchor locations that is at the opposite side of the reference point.

Clause 54. The apparatus of clause 51, wherein the means for identifying the set of candidate anchor locations comprises: means for identifying a first region that encompasses a first cluster of the set of candidate anchor nodes: means for identifying a second region that encompasses a second cluster of the set of candidate anchor nodes: and means for identifying one of the set of candidate anchor locations that is between the first region and the second region.

Clause 55. The apparatus of clause 54, further comprising: means for updating the set of candidate anchor nodes based on at least the identified one of the set of candidate anchor locations that is between the first region and the second region.

Clause 56. The apparatus of clause 51, wherein the means for identifying the set of candidate anchor locations comprises: means for identifying one of the set of candidate anchor nodes that has no line-of-sight path to the target node: and means for identifying one of the set of candidate anchor locations based on the mobility capability of the one of the set of candidate anchor nodes, the identified one of the candidate anchor locations has a line-of-sight path to the target node.

Clause 57. The apparatus of any of clauses 49 to 56, further comprising: means for receiving an indication from a candidate anchor node of the subset of the set of candidate anchor nodes, the indication indicating whether moving the candidate anchor node based on the set of candidate anchor locations by the positioning time is successful: and means for updating the set of candidate anchor nodes, the set of candidate anchor locations, or a combination thereof.

Clause 58. The apparatus of any of clauses 49 to 57, wherein the set of candidate anchor locations is identified based on an estimated geometric dilution of precision (GDOP) of the position estimation of the target node, node types of the set of candidate anchor nodes, a network topology of the set of candidate anchor nodes, a line-of-sight condition, or a combination thereof.

Clause 59. The apparatus of any of clauses 49 to 58, wherein the set of candidate anchor nodes is identified based on one or more last recorded positions of the target node, one or more established communication connections with the target node, one or more signal strengths of signals measured by the target node, an estimated geometric dilution of precision (GDOP) of the position estimation of the target node, node types of the set of candidate anchor nodes, node capabilities of the set of candidate anchor nodes, or a combination thereof.

Clause 60. The apparatus of any of clauses 49 to 59, wherein g the set of candidate anchor nodes is identified based on one or more suggested anchor nodes provided by the target node.

Clause 61. The apparatus of any of clauses 49 to 60, further comprising: means for determining one or more moving plans of moving respective one or more of the set of candidate anchor nodes based on the set of candidate anchor locations: means for determining priority of the one or more moving plans based on impact of the one or more of the set of candidate anchor nodes to precision of the positioning the target node, collision avoidance of the one or more moving plans, or a combination thereof: means for determining, based on the priority, an execution sequence of the one or more moving plans or omission of a portion of the one or more moving plans.

Clause 62. The apparatus of any of clauses 49 to 61, wherein the means for configuring the set of candidate anchor nodes and the target node to engage in the positioning operations at the positioning time to determine the position estimation of the target node comprises: means for configuring the target node to perform a first position estimation procedure of the target node: means for configuring the target node to transmit first measurement reports to a server or at least one anchor node of the set of candidate anchor nodes to transmit second measurement reports to the server, the first measurement reports or the second measurement reports enabling the server to perform a second position estimation procedure of the target node: means for configuring the target node to transmit reference signals to another target node, receive reference signals from the other target node, transmit third measurement reports to the other target node, or a combination thereof, the reference signals or the third measurement reports enabling the other target node to perform a third position estimation procedure of the target node: or a combination thereof.

Clause 63. The apparatus of any of clauses 49 to 61, wherein the means for configuring the set of candidate anchor nodes and the target node to engage in the positioning operations at the positioning time to determine the position estimation of the target node comprises: means for configuring the target node to transmit first measurement reports to a server or at least one anchor node of the set of candidate anchor nodes to transmit second measurement reports to the server, wherein at least one measurement report of the first measurement reports or the second measurement reports includes a timestamp, information about a position of the target node or an anchor node that is involved in a reported measurement included in the at least one measurement report, or both.

Clause 64. The apparatus of any of clauses 49 to 63, further comprising: means for receiving, from the target node or at least one anchor node of the set of candidate anchor nodes, measurement reports including measurements of wireless signals between the target node and the at least one anchor node of the set of candidate anchor nodes: and means for determining position estimation of the target node based, at least in part, on the measurement reports.

Clause 65. The apparatus of any of clauses 49 to 64, wherein: the set of candidate anchor locations includes a plurality of anchor locations that at least one anchor node of the set of candidate anchor nodes is to be placed at different time points.

Clause 66. The apparatus of any of clauses 49 to 65, further comprising: means for obtaining two or more relative positions of the target node, wherein each position of the two or more relative positions is relative to a previous position of the two or more relative positions, wherein the position estimation of the target node is based on ranging measurements, angle measurements, timing measurements, or a combination thereof, between the target node and one or more anchor nodes, the two or more relative positions, and known locations of the one or more anchor nodes.

Clause 67. An apparatus for positioning a target node, comprising: means for identifying multiple anchor locations for an anchor node, the anchor node being placed at the multiple anchor locations at different time points: means for configuring the anchor node and the target node to engage in positioning operations based on the anchor node at the multiple anchor locations: and means for determining a position estimation of the target node based on results of the positioning operations.

Clause 68. The apparatus of clause 67, wherein the anchor node is an automated guided vehicle (AGV), and the anchor locations correspond to locations of charging stations for the AGV.

Clause 69. The apparatus of any of clauses 67 to 68, wherein the positioning operations include performing ranging, angle, and/or timing measurements between the target node and the anchor node based on one or more positioning reference signals between the target node and the anchor node.

Clause 70. An apparatus for positioning a target node, comprising: means for obtaining two or more relative positions of the target node, wherein each position of the two or more relative positions is relative to a previous position of the two or more relative positions; means for obtaining, for each position of the target node at the two or more relative positions, ranging measurements, angle measurements, timing measurements, or a combination thereof, between the target node and one or more anchor nodes: and means for determining an absolute position of the target node based on the two or more relative positions of the target node, the ranging measurements, and known locations of the one or more anchor nodes.

Clause 71. The apparatus of clause 70, further comprising means for determining the two or more relative positions based on one or more sensors installed on the target node.

Clause 72. The apparatus of any of clauses 70 to 71, wherein the apparatus is: a network server of location management function (LMF), a base station, or the target node.

Clause 73. A non-transitory computer-readable medium storing computer-executable instructions that, when executed by an apparatus for positioning a target node, cause the apparatus to: identify a set of candidate anchor nodes based on the target node: identify a set of candidate anchor locations based on location information of the target node, location information of the set of candidate anchor nodes, mobility capabilities of the set of candidate anchor nodes, or a combination thereof: instruct at least a subset of the set of candidate anchor nodes to move based on the set of candidate anchor locations: and configure the set of candidate anchor nodes and the target node to engage in positioning operations at a positioning time to determine a position estimation of the target node.

Clause 74. The non-transitory computer-readable medium of clause 73, wherein the location information of the target node indicates a coarse location of the target node.

Clause 75. The non-transitory computer-readable medium of any of clauses 73 to 74, wherein the set of candidate anchor locations is identified based on a distribution pattern for improving a geometric dilution of precision (GDOP) of the position estimation of the target node.

Clause 76. The non-transitory computer-readable medium of clause 75, wherein the instructions that cause the apparatus to identify the set of candidate anchor locations comprises instructions that cause the apparatus to: identify a region that encompasses the set of candidate anchor nodes: identify a reference point of the region: and identify one of the set of candidate anchor locations that is at an opposite side of the reference point with respect to the target node, at a distance different from a reference distance of the reference point with respect to the target node, or a combination thereof.

Clause 77. The non-transitory computer-readable medium of clause 76, further comprising computer-executable instructions that, when executed by the apparatus, cause the apparatus to: update the set of candidate anchor nodes based on at least the identified one of the set of candidate anchor locations that is at the opposite side of the reference point.

Clause 78. The non-transitory computer-readable medium of clause 75, wherein the instructions that cause the apparatus to identify the set of candidate anchor locations comprises instructions that cause the apparatus to: identify a first region that encompasses a first cluster of the set of candidate anchor nodes: identify a second region that encompasses a second cluster of the set of candidate anchor nodes: and identify one of the set of candidate anchor locations that is between the first region and the second region.

Clause 79. The non-transitory computer-readable medium of clause 78, further comprising computer-executable instructions that, when executed by the apparatus, cause the apparatus to: update the set of candidate anchor nodes based on at least the identified one of the set of candidate anchor locations that is between the first region and the second region.

Clause 80. The non-transitory computer-readable medium of clause 75, wherein the instructions that cause the apparatus to identify the set of candidate anchor locations comprises instructions that cause the apparatus to: identify one of the set of candidate anchor nodes that has no line-of-sight path to the target node: and identify one of the set of candidate anchor locations based on the mobility capability of the one of the set of candidate anchor nodes, the identified one of the candidate anchor locations has a line-of-sight path to the target node.

Clause 81. The non-transitory computer-readable medium of any of clauses 73 to 80, further comprising computer-executable instructions that, when executed by the apparatus, cause the apparatus to: receive an indication from a candidate anchor node of the subset of the set of candidate anchor nodes, the indication indicating whether moving the candidate anchor node based on the set of candidate anchor locations by the positioning time is successful: and update the set of candidate anchor nodes, the set of candidate anchor locations, or a combination thereof.

Clause 82. The non-transitory computer-readable medium of any of clauses 73 to 81, wherein the set of candidate anchor locations is identified based on an estimated geometric dilution of precision (GDOP) of the position estimation of the target node, node types of the set of candidate anchor nodes, a network topology of the set of candidate anchor nodes, a line-of-sight condition, or a combination thereof.

Clause 83. The non-transitory computer-readable medium of any of clauses 73 to 82, wherein the set of candidate anchor nodes is identified based on one or more last recorded positions of the target node, one or more established communication connections with the target node, one or more signal strengths of signals measured by the target node, an estimated geometric dilution of precision (GDOP) of the position estimation of the target node, node types of the set of candidate anchor nodes, node capabilities of the set of candidate anchor nodes, or a combination thereof.

Clause 84. The non-transitory computer-readable medium of any of clauses 73 to 83, wherein the set of candidate anchor nodes is identified based on one or more suggested anchor nodes provided by the target node.

Clause 85. The non-transitory computer-readable medium of any of clauses 73 to 84, further comprising computer-executable instructions that, when executed by the apparatus, cause the apparatus to: determine one or more moving plans of moving respective one or more of the set of candidate anchor nodes based on the set of candidate anchor locations: determine priority of the one or more moving plans based on impact of the one or more of the set of candidate anchor nodes to precision of the positioning the target node, collision avoidance of the one or more moving plans, or a combination thereof: determine, based on the priority, an execution sequence of the one or more moving plans or omission of a portion of the one or more moving plans.

Clause 86. The non-transitory computer-readable medium of any of clauses 73 to 85, wherein the instructions that cause the apparatus to configure the set of candidate anchor nodes and the target node to engage in the positioning operations at the positioning time to determine the position estimation of the target node comprises instructions that cause the apparatus to: configure the target node to perform a first position estimation procedure of the target node: configure the target node to transmit first measurement reports to a server or at least one anchor node of the set of candidate anchor nodes to transmit second measurement reports to the server, the first measurement reports or the second measurement reports enabling the server to perform a second position estimation procedure of the target node: configure the target node to transmit reference signals to another target node, receive reference signals from the other target node, transmit third measurement reports to the other target node, or a combination thereof, the reference signals or the third measurement reports enabling the other target node to perform a third position estimation procedure of the target node: or a combination thereof.

Clause 87. The non-transitory computer-readable medium of any of clauses 73 to 85, wherein the instructions that cause the apparatus to configure the set of candidate anchor nodes and the target node to engage in the positioning operations at the positioning time to determine the position estimation of the target node comprises instructions that cause the apparatus to: configure the target node to transmit first measurement reports to a server or at least one anchor node of the set of candidate anchor nodes to transmit second measurement reports to the server, wherein at least one measurement report of the first measurement reports or the second measurement reports includes a timestamp, information about a position of the target node or an anchor node that is involved in a reported measurement included in the at least one measurement report, or both.

Clause 88. The non-transitory computer-readable medium of any of clauses 73 to 87, further comprising computer-executable instructions that, when executed by the apparatus, cause the apparatus to: receive, from the target node or at least one anchor node of the set of candidate anchor nodes, measurement reports including measurements of wireless signals between the target node and the at least one anchor node of the set of candidate anchor nodes: and determine position estimation of the target node based, at least in part, on the measurement reports.

Clause 89. The non-transitory computer-readable medium of any of clauses 73 to 88, wherein: the set of candidate anchor locations includes a plurality of anchor locations that at least one anchor node of the set of candidate anchor nodes is to be placed at different time points.

Clause 90. The non-transitory computer-readable medium of any of clauses 73 to 89, further comprising computer-executable instructions that, when executed by the apparatus, cause the apparatus to: obtain two or more relative positions of the target node, wherein each position of the two or more relative positions is relative to a previous position of the two or more relative positions, wherein the position estimation of the target node is based on ranging measurements, angle measurements, timing measurements, or a combination thereof, between the target node and one or more anchor nodes, the two or more relative positions, and known locations of the one or more anchor nodes.

Clause 91. A non-transitory computer-readable medium storing computer-executable instructions that, when executed by an apparatus for positioning a target node, cause the apparatus to: identify multiple anchor locations for an anchor node, the anchor node being placed at the multiple anchor locations at different time points: configure the anchor node and the target node to engage in positioning operations based on the anchor node at the multiple anchor locations: and determine a position estimation of the target node based on results of the positioning operations.

Clause 92. The non-transitory computer-readable medium of clause 91, wherein the anchor node is an automated guided vehicle (AGV), and the anchor locations correspond to locations of charging stations for the AGV.

Clause 93. The non-transitory computer-readable medium of any of clauses 91 to 92, wherein the positioning operations include performing ranging, angle, and/or timing measurements between the target node and the anchor node based on one or more positioning reference signals between the target node and the anchor node.

Clause 94. A non-transitory computer-readable medium storing computer-executable instructions that, when executed by an apparatus for positioning a target node, cause the apparatus to: obtain two or more relative positions of the target node, wherein each position of the two or more relative positions is relative to a previous position of the two or more relative positions: obtain, for each position of the target node at the two or more relative positions, ranging measurements, angle measurements, timing measurements, or a combination thereof, between the target node and one or more anchor nodes: and determine an absolute position of the target node based on the two or more relative positions of the target node, the ranging measurements, and known locations of the one or more anchor nodes.

Clause 95. The non-transitory computer-readable medium of clause 94, further comprising computer-executable instructions that, when executed by the apparatus, cause the apparatus to determine the two or more relative positions based on one or more sensors installed on the target node.

Clause 96. The non-transitory computer-readable medium of any of clauses 94 to 95, wherein the apparatus is: a network server of location management function (LMF), a base station, or the target node.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of positioning a target node, comprising:
identifying a set of candidate anchor nodes based on the target node;
identifying a set of candidate anchor locations based on location information of the target node, location information of the set of candidate anchor nodes, mobility capabilities of the set of candidate anchor nodes, or a combination thereof;
instructing at least a subset of the set of candidate anchor nodes to move based on the set of candidate anchor locations; and
configuring the set of candidate anchor nodes and the target node to engage in positioning operations at a positioning time to determine a position estimation of the target node.

2. The method of claim 1, wherein the location information of the target node indicates a coarse location of the target node.

3. The method of claim 1, wherein the identifying the set of candidate anchor locations is based on a distribution pattern for improving a geometric dilution of precision (GDOP) of the position estimation of the target node.

4. The method of claim 3, wherein the identifying the set of candidate anchor locations comprises:
identifying a region that encompasses the set of candidate anchor nodes;
identifying a reference point of the region; and
identifying one of the set of candidate anchor locations that is at an opposite side of the reference point with respect to the target node, at a distance different from a reference distance of the reference point with respect to the target node, or a combination thereof.

5. The method of claim 4, further comprising:
updating the set of candidate anchor nodes based on at least the identified one of the set of candidate anchor locations that is at the opposite side of the reference point.

6. The method of claim 3, wherein the identifying the set of candidate anchor locations comprises:
identifying a first region that encompasses a first cluster of the set of candidate anchor nodes;
identifying a second region that encompasses a second cluster of the set of candidate anchor nodes; and
identifying one of the set of candidate anchor locations that is between the first region and the second region.

7. The method of claim 6, further comprising:
updating the set of candidate anchor nodes based on at least the identified one of the set of candidate anchor locations that is between the first region and the second region.

8. The method of claim 3, wherein the identifying the set of candidate anchor locations comprises:
identifying one of the set of candidate anchor nodes that has no line-of-sight path to the target node; and
identifying one of the set of candidate anchor locations based on the mobility capability of the one of the set of candidate anchor nodes, the identified one of the candidate anchor locations has a line-of-sight path to the target node.

9. The method of claim 1, further comprising:
receiving an indication from a candidate anchor node of the subset of the set of candidate anchor nodes, the indication indicating whether moving the candidate anchor node based on the set of candidate anchor locations by the positioning time is successful; and
based on the indication indicating that the moving the candidate anchor node by the positioning time is not successful, updating the set of candidate anchor nodes, the set of candidate anchor locations, or a combination thereof.

10. The method of claim 1, wherein the identifying the set of candidate anchor locations is performed based on
an estimated geometric dilution of precision (GDOP) of the position estimation of the target node,
node types of the set of candidate anchor nodes,
a network topology of the set of candidate anchor nodes,
a line-of-sight condition, or
a combination thereof.

11. The method of claim 1, wherein the identifying the set of candidate anchor nodes is performed based on
one or more last recorded positions of the target node,
one or more established communication connections with the target node,
one or more signal strengths of signals measured by the target node,
an estimated geometric dilution of precision (GDOP) of the position estimation of the target node,
node types of the set of candidate anchor nodes,
node capabilities of the set of candidate anchor nodes, or
a combination thereof.

12. The method of claim 1, wherein the identifying the set of candidate anchor nodes is performed based on one or more suggested anchor nodes provided by the target node.

13. The method of claim 1, further comprising:
determining one or more moving plans of moving respective one or more of the set of candidate anchor nodes based on the set of candidate anchor locations;
determining priority of the one or more moving plans based on
impact of the one or more of the set of candidate anchor nodes to precision of the positioning the target node,
collision avoidance of the one or more moving plans, or
a combination thereof; and
determining, based on the priority, an execution sequence of the one or more moving plans or omission of a portion of the one or more moving plans.

14. The method of claim 1, wherein the configuring the set of candidate anchor nodes and the target node to engage in the positioning operations at the positioning time to determine the position estimation of the target node comprises:
configuring the target node to perform a first position estimation procedure of the target node;
configuring the target node to transmit first measurement reports to a server or at least one anchor node of the set of candidate anchor nodes to transmit second measurement reports to the server, the first measurement reports or the second measurement reports enabling the server to perform a second position estimation procedure of the target node;
configuring the target node to transmit reference signals to another target node, receive reference signals from the other target node, transmit third measurement reports to the other target node, or a combination thereof, the reference signals or the third measurement reports enabling the other target node to perform a third position estimation procedure of the target node; or
a combination thereof.

15. The method of claim 1, wherein the configuring the set of candidate anchor nodes and the target node to engage in the positioning operations at the positioning time to determine the position estimation of the target node comprises:
configuring the target node to transmit first measurement reports to a server or at least one anchor node of the set of candidate anchor nodes to transmit second measurement reports to the server,
wherein at least one measurement report of the first measurement reports or the second measurement reports includes a timestamp, information about a position of the target node or an anchor node that is involved in a reported measurement included in the at least one measurement report, or both.

16. The method of claim 1, further comprising:
receiving, from the target node or at least one anchor node of the set of candidate anchor nodes, measurement reports including measurements of wireless signals between the target node and the at least one anchor node of the set of candidate anchor nodes; and
determining position estimation of the target node based, at least in part, on the measurement reports.

17. The method of claim 1, wherein:
the set of candidate anchor locations includes a plurality of anchor locations that at least one anchor node of the set of candidate anchor nodes is to be placed at different time points.

18. The method of claim 1, further comprising:
obtaining two or more relative positions of the target node, wherein each position of the two or more relative positions is relative to a previous position of the two or more relative positions,
wherein the position estimation of the target node is based on ranging measurements, angle measurements, timing measurements, or a combination thereof, between the target node and one or more anchor nodes, the two or more relative positions, and known locations of the one or more anchor nodes.

19. A method of positioning a target node, comprising:
identifying multiple anchor locations for an anchor node, the anchor node being placed at the multiple anchor locations at different time points;
configuring the anchor node and the target node to engage in positioning operations based on the anchor node at the multiple anchor locations; and
determining a position estimation of the target node based on results of the positioning operations.

20. The method of claim 19, wherein
the anchor node is an automated guided vehicle (AGV), and
the anchor locations correspond to locations of charging stations for the AGV.

21. The method of claim 19, wherein the positioning operations include performing ranging, angle, and/or timing measurements between the target node and the anchor node based on one or more positioning reference signals between the target node and the anchor node.

22. A method of positioning a target node, comprising:
obtaining two or more relative positions of the target node, wherein each position of the two or more relative positions is relative to a previous position of the two or more relative positions;
obtaining, for each position of the target node at the two or more relative positions, ranging measurements, angle measurements, timing measurements, or a combination thereof, between the target node and one or more anchor nodes; and
determining an absolute position of the target node based on the two or more relative positions of the target node, the ranging measurements, and known locations of the one or more anchor nodes.

23. The method of claim 22, further comprising determining the two or more relative positions based on one or more sensors installed on the target node.

24. The method of claim 22, wherein the method is performed by:
a network server of location management function (LMF),
a base station, or
the target node.

25. An apparatus for positioning a target node, comprising:
a memory;
at least one transceiver; and
at least one processor communicatively coupled to the memory and the at least one transceiver, the at least one processor configured to:
identify a set of candidate anchor nodes based on the target node;
identify a set of candidate anchor locations based on location information of the target node, location information of the set of candidate anchor nodes, mobility capabilities of the set of candidate anchor nodes, or a combination thereof;
instruct at least a subset of the set of candidate anchor nodes to move based on the set of candidate anchor locations; and
configure the set of candidate anchor nodes and the target node to engage in positioning operations at a positioning time to determine a position estimation of the target node.

26. The apparatus of claim 25, wherein the set of candidate anchor locations is identified based on a distribution pattern for improving a geometric dilution of precision (GDOP) of the position estimation of the target node.

27. The apparatus of claim 26, wherein the at least one processor configured to identify the set of candidate anchor locations comprises the at least one processor configured to:
identify a region that encompasses the set of candidate anchor nodes;
identify a reference point of the region; and
identify one of the set of candidate anchor locations that is at an opposite side of the reference point with respect to the target node, at a distance different from a reference distance of the reference point with respect to the target node, or a combination thereof.

28. The apparatus of claim 26, wherein the at least one processor configured to identify the set of candidate anchor locations comprises the at least one processor configured to:
identify a first region that encompasses a first cluster of the set of candidate anchor nodes;
identify a second region that encompasses a second cluster of the set of candidate anchor nodes; and
identify one of the set of candidate anchor locations that is between the first region and the second region.

29. The apparatus of claim 26, wherein the at least one processor configured to identify the set of candidate anchor locations comprises the at least one processor configured to:
identify one of the set of candidate anchor nodes that has no line-of-sight path to the target node; and
identify one of the set of candidate anchor locations based on the mobility capability of the one of the set of candidate anchor nodes, the identified one of the candidate anchor locations has a line-of-sight path to the target node.

30. The apparatus of claim 25, wherein the at least one processor is further configured to:
receive, via the at least one transceiver, an indication from a candidate anchor node of the subset of the set of candidate anchor nodes, the indication indicating whether moving the candidate anchor node based on the set of candidate anchor locations by the positioning time is successful; and
update, based on the indication indicating that the moving the candidate anchor node by the positioning time is not successful, the set of candidate anchor nodes, the set of candidate anchor locations, or a combination thereof.

31. The apparatus of claim 25, wherein the set of candidate anchor nodes is identified based on one or more suggested anchor nodes provided by the target node.

32. The apparatus of claim 25, wherein the at least one processor is further configured to:
determine one or more moving plans of moving respective one or more of the set of candidate anchor nodes based on the set of candidate anchor locations;
determine priority of the one or more moving plans based on
impact of the one or more of the set of candidate anchor nodes to precision of the positioning the target node,
collision avoidance of the one or more moving plans, or
a combination thereof; and
determine, based on the priority, an execution sequence of the one or more moving plans or omission of a portion of the one or more moving plans.

33. The apparatus of claim 25, wherein the set of candidate anchor locations is identified based on
an estimated geometric dilution of precision (GDOP) of the position estimation of the target node,
node types of the set of candidate anchor nodes,
a network topology of the set of candidate anchor nodes,
a line-of-sight condition, or
a combination thereof.

34. The apparatus of claim 25, wherein the set of candidate anchor nodes is identified based on
one or more last recorded positions of the target node,
one or more established communication connections with the target node,
one or more signal strengths of signals measured by the target node,
an estimated geometric dilution of precision (GDOP) of the position estimation of the target node,
node types of the set of candidate anchor nodes,
node capabilities of the set of candidate anchor nodes, or
a combination thereof.

35. An apparatus for positioning a target node, comprising:
a memory;
at least one transceiver; and
at least one processor communicatively coupled to the memory and the at least one transceiver, the at least one processor configured to:
identify multiple anchor locations for an anchor node, the anchor node being placed at the multiple anchor locations at different time points;
configure the anchor node and the target node to engage in positioning operations based on the anchor node at the multiple anchor locations; and
determine a position estimation of the target node based on results of the positioning operations.

36. The apparatus of claim 35, wherein
the anchor node is an automated guided vehicle (AGV), and
the anchor locations correspond to locations of charging stations for the AGV.

37. The apparatus of claim 35, wherein the positioning operations include performing ranging, angle, and/or timing measurements between the target node and the anchor node based on one or more positioning reference signals between the target node and the anchor node.

38. An apparatus for positioning a target node, comprising:
a memory;
at least one transceiver; and
at least one processor communicatively coupled to the memory and the at least one transceiver, the at least one processor configured to:
obtain two or more relative positions of the target node, wherein each position of the two or more relative positions is relative to a previous position of the two or more relative positions;
obtain, for each position of the target node at the two or more relative positions, ranging measurements, angle measurements, timing measurements, or a combination thereof, between the target node and one or more anchor nodes; and
determine an absolute position of the target node based on the two or more relative positions of the target node, the ranging measurements, and known locations of the one or more anchor nodes.

39. The apparatus of claim 38, wherein the at least one processor is further configured to determine the two or more relative positions based on one or more sensors installed on the target node.

40. The apparatus of claim 38, wherein the apparatus is:
a network server of location management function (LMF),
a base station, or
the target node.
